(19) United States
(12) Patent Application Publication
(10) Pub. No.: US 2011/0046938 A1
(43) Pub. Date: Feb. 24, 2011

(54) Verification apparatus and design verification program

(75) Inventors: Rafael Kazumiti Morizawa, Kawasaki (JP); Praveen Kumar Murthy, Fremont, CA (US)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/654,896

(22) Filed: Jan. 7, 2010

Related U.S. Application Data
(60) Provisional application No. 61/272,135, filed on Aug. 19, 2009.

(51) Int. Cl. G06F 9/44

(52) U.S. Cl. 703/28

(57) ABSTRACT

A design verification apparatus includes a dataset generator to generate verification datasets which associate each unit process of a plurality of procedures (processing scenarios) described in a design specification of a target product with an identifier (label) designating which portion of the design specification is to be verified. A process priority setting unit assigns a process priority to each verification dataset according to specified identifiers. An output processor outputs data identifying the verification datasets, together with explicit indication of their process priorities.

### CROSS-REFERENCE TO RELATED APPLICATION(S)

This application is based upon and claims the benefit of priority of U.S. Provisional Application No. 61/272,135, filed on Aug. 19, 2009, the entire contents of which are incorporated herein by reference.

### FIELD

The embodiments discussed herein relate to an apparatus and a program for performing design verification.

### BACKGROUND

Recent advancement of design technologies has enabled development of increasingly large-scale software and hardware products. To pursue the design process while ensuring that the product under development will work as it is intended, the stage of design and development involves design verification. This verification task is becoming more and more part of a development process because of the increasing scale of target products as noted above. The deadline of a development project, on the other hand, may sometimes be moved up, and the actual number of man-hours may exceed the estimation. For those reasons, it is not unusual for the project to encounter the problem of insufficient time for development.

In view of the above, several techniques are proposed to improve the efficiency of verification tasks. For example, the following documents describe several techniques directed to extraction of test items for a specific verification step to reduce the time required for design and development.

U.S. Pat. No. 7,275,231

Japanese Laid-open Patent Publication No. 2006-85710

Japanese Laid-open Patent Publication No. 2004-185592

The extracted test items are then subjected to a verification process. However, testing them in a random order is not efficient at all because, if a desired test was placed in a later part of the verification process, it would take a long time for the user to receive an error report from that test.

While the verification process includes a significant number of test steps, the scheduling of those steps depends on the expertise of users (i.e., design engineers and test engineers). They choose an appropriate verification procedure to prioritize their desired tests. Inexperienced engineers, however, lack this expertise for efficient verification, thus failing to choose a correct sequence of test steps.

### SUMMARY

According to an aspect of the invention, there is provided a design verification apparatus including the following elements: a dataset generator to generate verification datasets which associate each unit process of a plurality of procedures described in a design specification of a target product with an identifier designating which portion of the design specification is to be verified; a process priority setting unit to assign a process priority to each verification dataset according to specified identifiers; and an output processor to output data identifying the verification datasets, together with explicit indication of process priorities thereof.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWING(S)

FIGS. 1 and 2 illustrate a design verification apparatus according to a first embodiment;

FIG. 3 illustrates a system according to a second present embodiment;

FIG. 4 illustrates a structure of an LSI design specification according to the present embodiment;

FIG. 5 illustrates an example data structure of an LSI design specification;

FIG. 6 illustrates relationships between message sequence charts and their hierarchical structure;

FIG. 7 illustrates a structure of a message sequence chart;

FIG. 8 illustrates an another example of a message sequence chart;

FIG. 9 illustrates an example of hardware configuration of the design verification apparatus;

FIG. 10 is a functional block diagram of the design verification apparatus;

FIG. 11 is a flowchart that gives a general view of what the design verification apparatus performs;

FIGS. 12 and 13 are a flowchart of a verification scenario generation process;

FIG. 14 is a flowchart of a labeling process;

FIG. 15 is a flowchart of a priority setting process;

FIG. 16 illustrates an example data structure of an LSI design specification;

FIGS. 17A to 17C illustrate specific examples of message sequence charts;

FIGS. 18 to 20 give several specific examples of labeled LSI design specifications;

FIG. 21 illustrates a data structure of a labeled LSI design specification;

FIG. 22 gives another example of a labeled LSI design specification;

FIG. 23 is a message sequence chart illustrating a conversion process to produce a finite state machine;

FIG. 24 illustrates a state matrix corresponding to the message sequence chart of FIG. 23;

FIG. 25 is a state diagram corresponding to a state matrix;

FIG. 26 illustrates a specific example of how labels are added to a finite state machine;

FIG. 27 depicts a final view of the labeled finite state machine;

FIG. 28 is a state diagram corresponding to a state matrix;

FIG. 29 illustrates an example data structure of a finite state machine;

FIG. 30 illustrates verification scenarios stored in a verification scenario database;

FIGS. 31 and 32 illustrate a data structure of prioritized verification scenarios;

FIG. 33 illustrates a specific example of a priority list;

FIG. 34 is a block diagram illustrating a system according to a third embodiment;

FIG. 35 gives a general view of what is performed by the design verification apparatus of the third embodiment;

FIG. 36 is a flowchart of a verification scenario generation process according to the third embodiment;

FIG. 37 is a flowchart of a verification scenario extraction process;

FIG. 38 illustrates an example data structure of an LSI design specification according to the third embodiment;

FIG. 39 illustrates relationships between message sequence charts and their hierarchical structure according to the third embodiment;

FIG. 40 illustrates a message sequence chart for scenario “Query”;

FIGS. 41 and 42 present specific examples of how labels are added to an LSI design specification according to the third embodiment;

FIG. 43 illustrates a directed graph which has undergone a labeling process;

FIG. 44 illustrates an example data structure of a labeled LSI design specification;

FIG. 45 illustrates an example of object names added to labels;

FIG. 46 depicts a final view of the labeled finite state machine;

FIG. 47 illustrates a data structure of the finite state machine with labels to which message names and object names of sending and receiving ends have been added; and

FIGS. 48 and 49 illustrate examples of how an intersection of extracted verification scenarios is calculated.

### DESCRIPTION OF EMBODIMENT(S)

Preferred embodiments of the present invention will be described below with reference to the accompanying drawings, wherein like reference numerals refer to like elements throughout. The following description begins with an overview of a design verification apparatus according to a first embodiment and then proceeds to more specific embodiments of the invention.

### First Embodiment

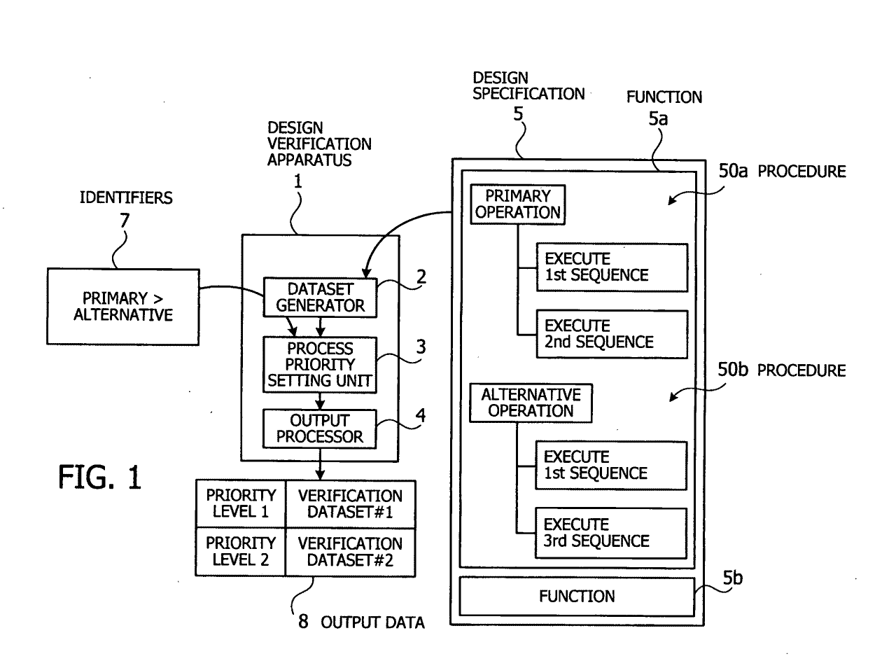

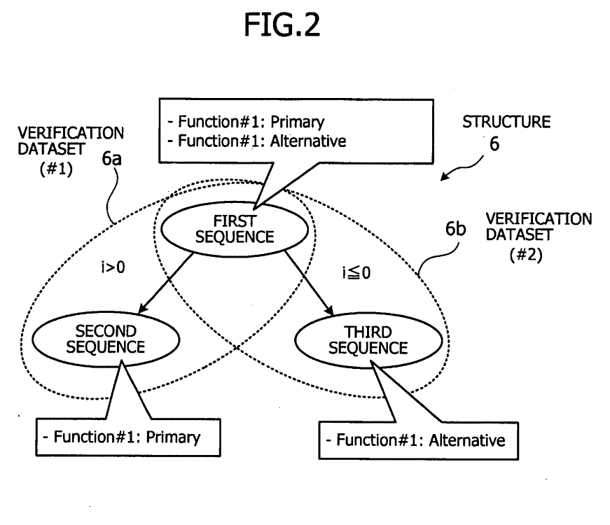

FIGS. 1 and 2 illustrate a design verification apparatus according to a first embodiment. This design verification apparatus 1 includes a dataset generator 2, a process priority setting unit 3, and an output processor 4.

The dataset generator 2 generates verification datasets which associate each unit process of a plurality of procedures (or processing scenarios) described in a design specification of a target product with an identifier (or label) designating which portion of the design specification is to be verified. The generated verification datasets are used to verify a specific procedure (e.g., whether the procedure works as it is intended). Here the term “target product” refers to a specific object to be tested and verified by the design verification apparatus 1, which may be, for example, hardware components, software modules, or a system thereof. The design specification of a target product describes what its implementation should comply with. A design specification is formed from at least one function.

Also illustrated in FIG. 1 is a design specification 5 including two functions 5a and 5b. The function 5a is realized by its two constituent procedures 50a and 50b. The former procedure 50a defines a primary operation of the function 5a, while the latter procedure 50b defines an alternative operation which may execute in place of the primary operation.

The illustrated procedure 50a of FIG. 1 has a branch structure in which the nodes represent unit processes of the primary operation. Those unit processes may include, for example, one or more message sequence charts to define interactions between all objects involved in the function 5a. For details of message sequence chart, see U.S. Pat. No. 7,275,231 and Japanese Laid-open Patent Publication No. 2006-85710.

The relationships between two procedures 50a and 50b are defined by a structure 6 depicted in FIG. 2. This structure 6 represents the design specification 5 in a compact way, in which first to third sequences are associated by branches and merges that indicate their relationships. The arrows connecting those sequence blocks indicate in what order the described functions are executed. Specifically, the procedure 50a executes the first sequence and second sequence in that order, and the procedure 50b executes the first sequence and third sequence in that order. That is, the illustrated structure 6 indicates that those two procedures operate in the same way up to the first sequence, but will then be diverted into different operations.

The edges of this structure 6 are directional edges each having a specific guard condition. Those guard conditions describe under what conditions a transition from one sequence to another sequence occurs. For example, FIG. 2 illustrates two guard conditions, i.e., i>0 and i<=0. Specifically, the process is allowed to proceed from the first sequence to the second sequence if i>0 when the first sequence is finished. The process may instead go to the third sequence if i<=0 at that time.

For the function 5a illustrated in FIG. 1, the dataset generator 2 produces verification datasets which associate each of the first and second sequences of the procedure 50a of primary operation with identifiers designating which portion of the given design specification is to be verified. What is verified in this case is a function, procedure, or unit process of the design specification. In the example of FIG. 2, the first and second sequences are both associated with an identifier “Function#1” representing the function 5a and another identifier “Primary” (primary operation) representing the procedure 50a.

The dataset generator 2 also produces verification datasets for another procedure 50b describing alternative operation of the function 5a, so as to associate each of the first and third sequences with portions of the given design specification. In the example of FIG. 2, the first and third sequences are both associated with an identifier “Function#1” representing the function 5a and another identifier “Alternative” (alternative operation) representing the procedure 50b.

As a result of the above processing by the dataset generator 2, the first sequence has gained two lines of identifiers, “Function#1: Primary” and “Function#1: Alternative.” The second sequence has gained a single line of identifiers “Function#1: Primary.” The third sequence has gained a single line of identifiers “Function#1: Alternative.” The dataset generator 2 then identifies sequences sharing a particular identifier and extracts each such set of sequences as a verification dataset. In the present example of FIG. 2, the first and second sequences constitute one verification dataset for “Primary” operation, while the first and third sequences constitute another verification dataset for “Alternative” operation.

Referring back to FIG. 1, the process priority setting unit 3 assigns a process priority to each produced verification dataset according to a specified set of identifiers 7. Suppose, for example, that identifiers “primary operation” and “alternative operation” are specified, as illustrated in FIG. 1. Assuming in this case that primary operation is supposed to have a higher process priority than alternative operation, the process priority setting unit 3 assigns a priority level “1” to the verification dataset 6a in preference to the other verification dataset 6b, which is given a lower priority level “2.”

The output processor 4 outputs data identifying the prioritized verification datasets 6a and 6b, together with explicit indication of their process priorities. In the example of FIG. 1, the output processor produces output data 8 containing two records. One record indicates verification dataset #1 (verification dataset 6a in FIG. 2) and its priority level “1,” and the other record indicates verification dataset #2 (verification dataset 6b in FIG. 2) and its priority level “2.”

According to the above-described design verification apparatus 1, the dataset generator 2 is configured to produce verification datasets 6a and 6b, and the process priority setting unit 3 is configured to assign a priority level to each verification dataset, depending on which portions of a given design specification are to be verified and what their process priorities are. These features help the user to determine which portions to verify in what process priorities. The user can therefore verify his/her target product more efficiently by using the verification datasets in the order of their assigned priorities.

While the above-described first embodiment is configured such that the process priority setting unit 3 will directly receive and manipulate verification datasets 6a and 6b produced by the dataset generator 2, the invention is not limited by this specific configuration. For example, the design verification apparatus 1 may employ a storage area for those verification datasets 6a, 6b, so that the process priority setting unit 3 will manipulate them in response to a user input that specifies which portion to verify. The following sections will now describe more specific embodiments of the invention.

### Second Embodiment

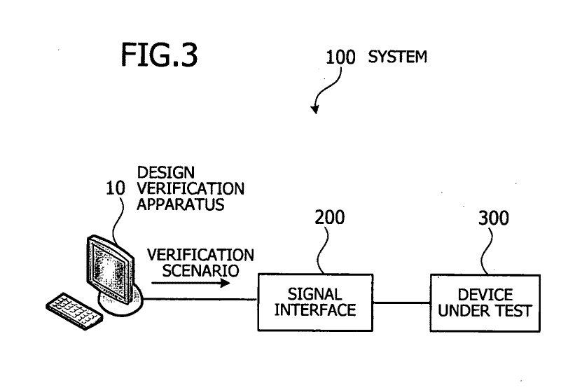

FIG. 3 illustrates a system according to a second embodiment. The illustrated system 100 involves a design verification apparatus 10, a signal interface 200, and a device under test 300.

The design verification apparatus 10 is used to test whether the target device 300 will operate as specified in its design specification. To this end, the design verification apparatus 10 produces a verification scenario for each processing scenario described in the design specification. The design verification apparatus 10 then assigns priorities to the produced verification scenarios. The design verification apparatus 10 interacts with the device 300 under test via the signal interface 200 so as to test whether the device 300 can operate in accordance with those prioritized verification scenarios. In this test process, the priorities of verification scenarios are used to determine in what order those scenarios should be applied to the device 300 under test.

The signal interface 200 is a device that permits the design verification apparatus 10 to communicate with the device 300 under test by converting their signals into each other's form. This signal interface 200 may be omitted in the case where, for example, the design verification apparatus 10 and device under test 300 are compatible in their signal specifications.

The device 300 under test is what will be tested and verified by the design verification apparatus 10. For example, hardware components, software modules, or their system are subjected to the design verification apparatus 10. The device 300 may be a physical device such as a product prototype manufactured in the course of product development, or a logical simulation model such as a state machine created on the design verification apparatus 10. The following description assumes that a large-scale integration (LSI) chip is under development and thus subjected to the test.

(a) Design Specification of LSI Chip

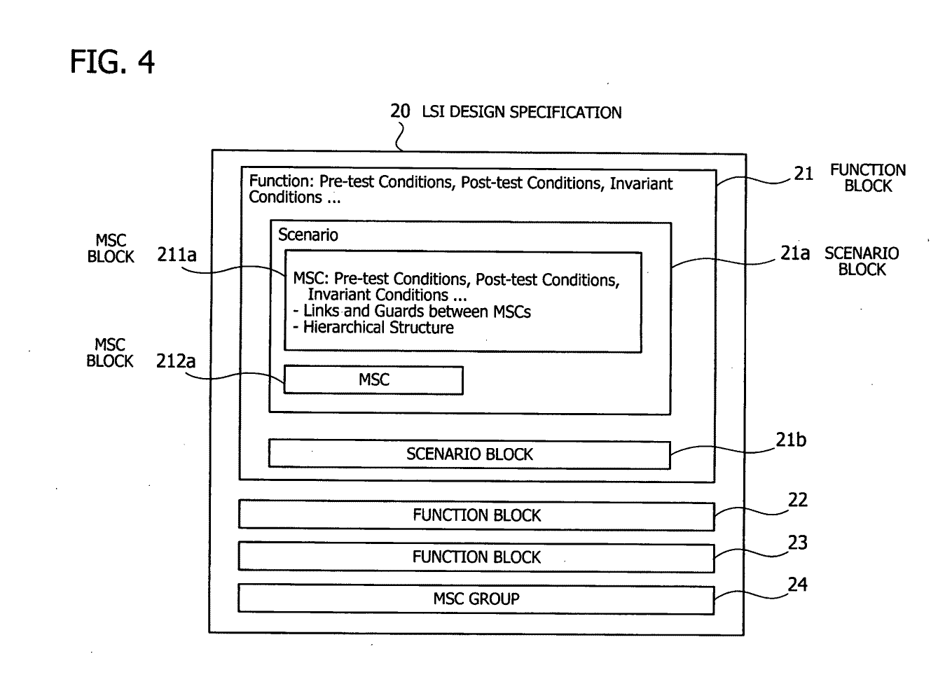

FIG. 4 illustrates a structure of an LSI design specification according to the present embodiment. As mentioned above, a design specification is provided as a collection of functions that describe what the implementation should comply with. The illustrated LSI design specification 20 is organized in list structure, using Extensible Markup Language (XML), for example. Each function block 21, 22, and 23 describes a single function, which may be, for example, a hardware function called up by a software module, or a software function dependent on some hardware components. Those function blocks 21, 22, and 23 have one or more scenario blocks. Specifically, the illustrated function block 21 contains two scenario blocks 21a and 21b.

Each scenario block 21a and 21b describes a single scenario that plays a substantive role in realizing the intended function. A function may include two or more scenarios corresponding to different calling conditions. More specifically, a scenario defines a series of operations to be executed to realize an intended function. To put it in another way, a scenario gives an ordered set of messages exchanged between objects.

Each scenario block 21a and 21b contains one or more message sequence chart (MSC) blocks. In the example of FIG. 4, the illustrated scenario block 21a contains two MSC blocks 211a and 212a. Those MSC blocks 211a and 212a each correspond to a single message sequence chart.

A message sequence chart gives a set of sub-functions offered by the scenario. More specifically, message sequence charts provide a clear definition of what interactions will be made between all objects involved in the function. Such objects may include functions described in the LSI design specification 20, as well as an external environment which may interact with the system including that LSI chip.

(b) Data Structure of LSI Design Specification

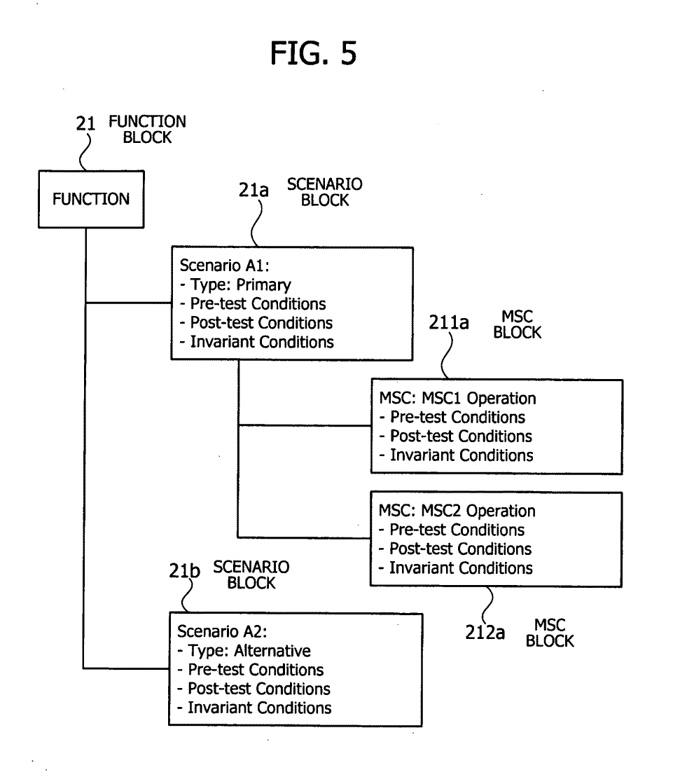

Referring to FIG. 5, an example data structure of an LSI design specification is illustrated. As mentioned above, the LSI design specification 20 is provided as a collection of functions. FIG. 5 depicts, in tree form, one of those functions in the design specification of FIG. 4.

As discussed above, the function block 21 defines a function which includes two scenarios A1 and A2 described in scenario blocks 21a and 21b, respectively. Each of those scenarios A1 and A2 bears a specific property, i.e., “Primary” (primary operation) or “Alternative” (alternative operation) or “Exceptional” (exceptional operation). The scenario blocks 21a and 21b indicate this property under the title of “Type.”

In addition, those scenarios A1 and A2 may include one or more definitions of pre-test condition, post-test condition, and invariant condition as their execution conditions. Specifically, pre-test conditions are what have to be satisfied (i.e., conditions that return a value of “true” when tested) before starting a defined series of operations to execute a function. Post-test conditions are what have to be satisfied when such a series of operations is completed. Invariant conditions are what are required until the post-test conditions become true (i.e., during the course of the series of operations). In the example of FIG. 5, scenario A1 of primary operation includes such pre-test, post-test condition, and invariant conditions, as does scenario A2 of alternative operation.

Message sequence charts of MSC blocks 211a and 212a are distinguished by their respective identifiers, “MSC1 Operation” and “MSC2 Operation.” These message sequence charts may include one or more definitions of pre-test condition, post-test condition, and invariant condition as their execution conditions. The former message sequence chart “MSC1 Operation” includes pre-test, post-test condition, and invariant conditions, as does the latter message sequence chart “MSC2 Operation”. While FIG. 5 does not illustrate it explicitly, there is at least one MSC block for the other scenario block 21b.

The LSI design specification 20 may also be represented as a single directed graph including a plurality of message sequence charts, or as a single message chart with a flat structure. In the latter case, the message sequence charts indicate the order of messages exchanged between objects. As yet another alternative method, the LSI design specification 20 may be represented as a plurality of cross-embedded directed graphs and a plurality of message sequence charts.

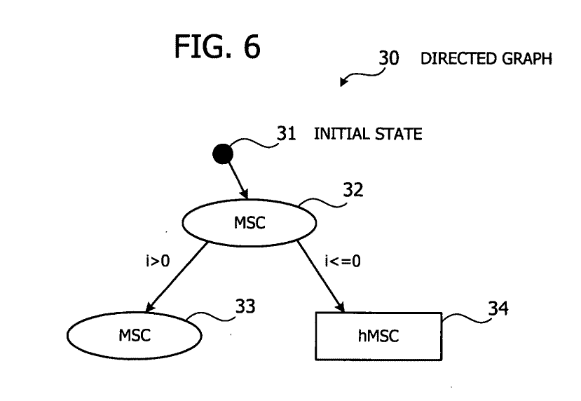

FIG. 6 illustrates relationships between message sequence charts and their hierarchical structure. According to the present embodiment, the LSI design specification 20 is hierarchically structured in the form of a directed graph 30. This directed graph 30 offers a compact representation of the LSI design specification 20.

The directed graph 30 includes a plurality of message sequence charts, and branches and merges that indicate relationships between those charts, as mentioned above. These relationships permit the message sequence charts to be sorted into one or more sequences.

The message sequence charts indicate relationships between objects. That is, each message sequence chart is used to identify messages exchanged between objects and figure out in what order at least part of such messages are transmitted.

The illustrated directed graph 30 describes relationships between a plurality of functions executed by a particular function to authenticate prospective users. These functions are defined and visualized by message sequence charts. Each message sequence chart corresponds to a specific function, and the arrows interconnecting blocks indicate the execution order of the functions. The edges of the directed graph 30 are directional edges with optional guard conditions.

The directed graph 30 of FIG. 6 includes three functions represented respectively by two distinct message sequence charts 32 and 33 and a hierarchical message sequence chart (hMSC) 34. Here the hierarchical message sequence chart 34 expresses a hierarchy of message sequence charts in a collective manner. The solid circle is an initial state block 31, which serves as a pseudo state to provide an entry point of the directed graph 30. Specifically, the initial state block 31 specifies which hierarchical message sequence chart will be activated in the first place. That is, the arrow drawn from this initial state block 31 to the message sequence chart 32 indicates that a sequence of messages corresponding to the message sequence chart 32 will be communicated immediately upon entry to the directed graph 30. This communication of messages is then followed by either the message sequence chart 33 or the hierarchical message sequence chart 34.

As can be seen from the above explanation, the illustrated directed graph 30 includes two scenarios. That is, one scenario proceeds along a path that extends from the initial state block 31 to the topmost message sequence chart 32, and then down to the bottom-left message sequence chart 33 in FIG. 6. The other scenario goes from the initial state block 31 to the message sequence chart 32 and then proceeds to the hierarchical message sequence chart 34. Accordingly, both scenarios operate in the same way up to the message sequence chart 32, but will then be diverted into different operations.

As noted above, the directed graph 30 has directional edges with guard conditions. Upon completion of messages given by the current message sequence chart, the guard condition of each edge is tested. If either condition is met, then a transition to the corresponding destination message sequence chart takes place. In the case of hMSC, the destination of this transition is its constituent message sequence chart in the same hierarchical level.

In the example of FIG. 6, one guard condition “i>0” brings the state from the current message sequence chart 32 to the next message sequence chart 33. In the case where the other guard condition “i<=0” is met, the state moves instead to the hierarchical message sequence chart 34. This information serves effectively in making a complete verification of the directed graph 30 without duplicated execution of common portions of two scenarios.

Note here that message sequence charts in such a single directed graph 30 may refer to the same set of objects. Also, the directed graph 30 may be associated with some rules requiring that every message defined in a certain message sequence chart be executed before the next message sequence chart on the path becomes executable. The next section will describe a typical structure of message sequence charts.

(c) Message Sequence Chart

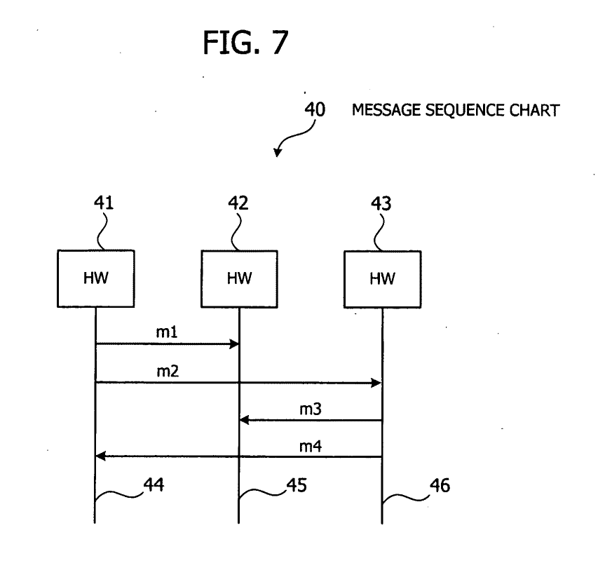

FIG. 7 illustrates an example structure of a message sequence chart. As described earlier, message sequence charts provide a clear definition of what interactions will be made between all objects involved in a function. Message sequence charts involves, for example, hardware blocks of an LSI chip under development or objects serving as an external environment which may interact with a system under development.

The message sequence chart 40 illustrated in FIG. 7 includes a plurality of hardware (HW) objects 41, 42, and 43 and depicts a series of data event messages to be exchanged after such objects are generated. Data event messages may be specified by the user. That is, the user is allowed to specify what messages are communicated between which objects. For example, the user selects one object and then another object by using a pointing tool (not illustrated). The selected objects are formed into a message sequence chart 40 in which a data event message is sent from the first-selected object having a transmit event to the second-selected object having a receive event.

The message sequence chart 40 is produced in this way to represent four data event messages m1 to m4 exchanged between hardware objects 41, 42, and 43 as indicated by the four arrows. As can be seen from the example of FIG. 7, object lines 44, 45, and 46 extend downward from the respective hardware objects 41, 42 and 43, and horizontal arrows are drawn between those object lines 44, 45, and 46 to represent inter-object data event messages. In other words, a data event message associates a transmitting object with a receiving object. The points at which those object line 44, 45, and 46 meet data event messages m1 to m4 are called “events.”

Each data event message includes a transmit event associated with its transmitting object and a receive event associated with its receiving object. For example, the topmost data event message m1 in FIG. 7 runs between two object lines 44 and 45, meaning that the data event message m1 associates one hardware object 41 with a transmitting object, as well as another hardware object 42 with a receiving object. The data event message m1 further gives a transmit event at its one end point on the object line 44 and a receive event at its other end point on the object line 45.

Such object and event relationships defined in a message sequence chart are supposed to comply with the following two rules: The first rule requires that the transmit event s(m) of a data event message m precede its corresponding receive event r(m). This rule is expressed as s(m)<r(m). The second rule requires that the events on an object line be sequenced from the top to the bottom.

The above two rules mean that message sequence charts describe the order of data event messages between objects. For example, according to the first rule, the transmit event of data event message m1 occurs before the receive event of the same. According to the second rule, on the other hand, the transmit event of data event message m2 occurs before the receive event of data event message m4. The same applies to other data event messages in FIG. 7.

Referring to the time axis of the leftmost hardware object 41, data event messages m1 and m2 are transmitted in that order, and data event message m4 is received thereafter. On the time axis of the next hardware object 42, data event messages m1 and m3 arrive in that order. On the time axis of the rightmost hardware object 43, data event message m2 arrives first, and then data event messages m3 and m4 are transmitted in that order.

The above rules are transitive. For example, when event e1 precedes event e2 (i.e., e1<e2), and when event e2 precedes event e3 (e2<e3), this means that event e1 precedes event e3 (e1<e3). The two rules, however, may not necessarily govern all ordered relationships between data event messages. Think of, for example, a message sequence chart that contains four objects and only two data event messages. In this message sequence chart, a first data event message is sent from a first object to a second object, and a second data event message is sent from a third object to a fourth object. The foregoing two rules, however, provide no particular order of those two data event messages in this example case. That is, the two data event messages can be sent in either order.

The hardware objects 42 and 43 in the example of FIG. 7 do not share their ordinal relationships on the time axis. Accordingly, the topmost data event message (data receive event message) m1 and second data event message (data receive event message) m2 may swap their positions in the sequence. Likewise, the third data event message (data receive event message) m3 and fourth data event message (data receive event message) m4 may swap their positions since the hardware objects 41 and 42 do not share their ordinal relationships on the time axis.

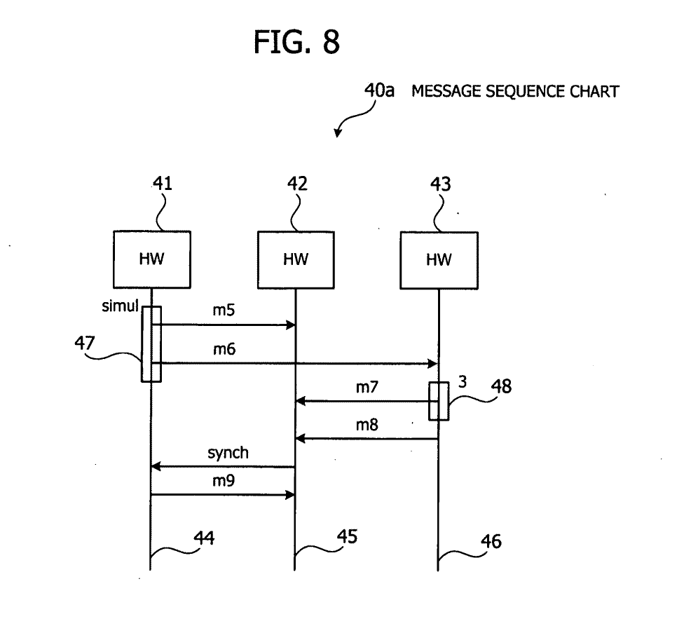

FIG. 8 illustrates another example of a message sequence chart. The illustrated message sequence chart 40a includes three hardware objects 41, 42, and 43, where the sequence is defined with three enhanced functions that are referred to as simultaneity constraint, timeout constraint, and synchronization edge. FIG. 8 depicts a simultaneity constraint and a timeout constraint in the form of a box enclosing events.

Specifically, the box 47 labeled “simul” represents a simultaneity constraint. This box 47 binds enclosed events into a group of simultaneous events. In the example of FIG. 8, the box 47 binds two transmit events associated with data event messages m5 and m6.

The box 48 represents a timeout constraint, with an integer number affixed to indicate a specific timeout value. When such a timeout constraint is encountered during the execution of a sequence, the execution is suspended until the specified timeout period expires. In this timed execution model, the sequence cannot resume until the expiration of a given timeout period. In the example of FIG. 8, data event message m7 is transmitted after a lapse of three unit times, as indicated by the label “3” beside the box 48.

Synchronization edges are used to establish a fixed ordinal relationship between data event messages. Synchronization edges have the same appearance as ordinary data event messages, except that they are labeled “synch.” Accordingly, data event messages having a label of “synch” will be referred to as synchronization messages.

Think of, for example, a synchronization edge including a transmit event on one hardware object 42 and a receive event on another hardware object 41. In this case, a synchronization message is sent from the hardware object after it receives a data event message m8. The synchronization message is received by the hardware object 41 before it sends a data event message m9.

According to the message sequence chart 40a, the hardware object 42 is supposed to receive data event message m8 before the hardware object 41 sends data event message m9. A synchronization edge, if added, creates a relationship between objects that are otherwise unrelated to each other. According to an embodiment, however, synchronization edges do not actually produce any messages between interrelated objects. In FIG. 8, the synchronization message actually produces a transmit event for data event message m9 after receive events of data event messages m7 and m8, rather than sequencing those data event messages m7, m8, and m5 by comparing them with each other.

(d) Design Verification Apparatus

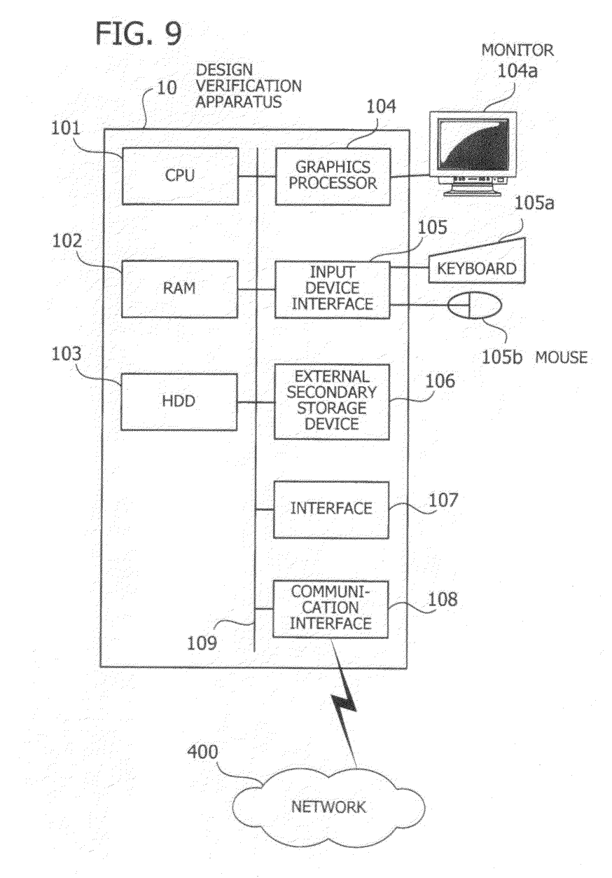

Referring now to the block diagram of FIG. 9, a hardware configuration of the design verification apparatus 10 will be described below.

The illustrated system has the following hardware elements: a central processing unit (CPU) 101, a random access memory (RAM) 102, a hard disk drive (HDD) 103, a graphics processor 104, an input device interface 105, an external secondary storage device 106, an interface 107 and a communication interface 108. The CPU 101 controls the entire computer system of this design verification apparatus 10, interacting with other elements via a bus 109. Specifically, the CPU 101 manipulates information received from the input device interface 105, external secondary storage device 106, interface 107, and communication interface 108.

The RAM 102 serves as temporary storage for the whole or part of operating system (OS) programs and application programs that the CPU 101 executes, in addition to other various data objects manipulated at runtime. Also stored in the RAM 102 are various data objects that the CPU 101 manipulates at runtime.

The HDD 103 stores program and data files of the operating system and applications. In addition, the HDD 103 stores list structures scripted with the Extensible Markup Language (XML).

The graphics processor 104, coupled to a monitor 104a, produces video images in accordance with drawing commands from the CPU 101 and displays them on a screen of the monitor 104a. The input device interface 105 is used to receive signals from external input devices, such as a keyboard 105a and a mouse 105b. Those input signals are supplied to the CPU 101 via the bus 109.

The external secondary storage device 106 reads data from, and optionally writes data to, a storage medium. Such storage media include magnetic storage devices, optical discs, magneto-optical storage media, and semiconductor memory devices, for example. Magnetic storage devices include hard disk drives (HDD), flexible disks (FD), and magnetic tapes, for example. Optical discs include digital versatile discs (DVD), DVD-RAM, compact disc read-only memory (CD-ROM), CD-Recordable (CD-R), and CD-Rewritable (CD-RW), for example. Magneto-optical storage media include magneto-optical discs (MO), for example.

The interface 107 is a hardware device configured to transmit and receive data to/from an external device connected to the design verification apparatus 10. Specifically, the interface 107 is used to communicate with a device 300 under test through a signal interface 200 (see FIG. 2).

The communication interface 108 is connected to a network 400, allowing the CPU 101 to exchange data with other computers (not illustrated) on the network 400.

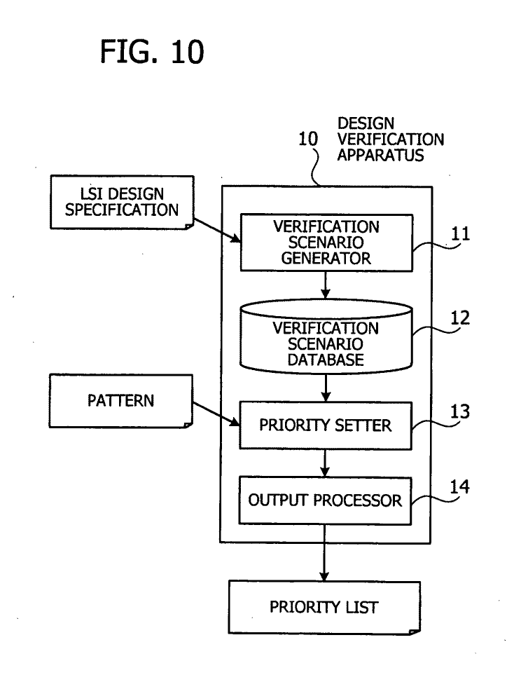

The processing functions of the present embodiment (as well as subsequent embodiments) can be realized on such a hardware platform. FIG. 10 is a block diagram illustrating functions provided in the design verification apparatus 10. The design verification apparatus 10 includes a verification scenario generator 11, a verification scenario database 12, a priority setter 13, and an output processor 14.

The verification scenario generator 11 has access to the data of an LSI design specification 20 discussed in FIGS. 4 and 5. The verification scenario generator 11 also has access to messages sequence charts (not illustrated) which realize scenarios corresponding to scenario blocks 21a and 21b (FIGS. 4 and 5). The design verification apparatus 10 may be configured to receive message sequence charts from some external source. According to a given LSI design specification 20, the verification scenario generator 11 produces a verification scenario for each processing scenario described in the design specification.

These verification scenarios associate a message sequence chart of each scenario in the given LSI design specification 20 with labels (identifiers) obtained from that design specification. Here the associated labels designate which portion of the design specification (e.g., a specific function, scenario, or message sequence chart) is to be verified. Verification scenarios serve as a kind of intermediate data for subsequent processing by the priority setter 13. While not explicitly illustrated in FIG. 10, the verification scenario generator 11 has a temporary memory to store data produced in the course of verification scenario generation.

The verification scenario database 12 is where the verification scenarios produced by verification scenario generator 11 are stored for subsequent use.

The priority setter 13 assigns priority levels (process priorities) to verification scenarios, according to a pattern provided by the user. This pattern may include, among others, data equivalent to the foregoing identifiers. More specifically, the pattern includes at least one logical combination of function names, scenario names, scenario types (primary operation, alternative operation, exceptional operation), MSC names, and the like.

Some patterns may specify process priorities. With respect to scenario types, an example pattern “Primary>Exceptional” places primary operation in preference to exceptional operation. With respect to MSC names, an example pattern “Authentication Done>Query” gives a higher priority to successful authentication than query. Yet another example “Authentication Failed>Authentication Done>Query” prioritizes failed authentication over successful authentication.

The output processor 14 sorts verification scenarios in the order of their priorities assigned by the priority setter 13. The output processor 14 then compiles a list of names that enumerates prioritized verification scenarios according to a predefined format and outputs the resulting priority list. Optionally, the output processor may be configured to arrange verification scenarios according to user-specified sort conditions. While not illustrated in FIG. 10, the design verification apparatus 10 may include some tools for generating message sequence charts or creating a state machine based on given message sequence charts.

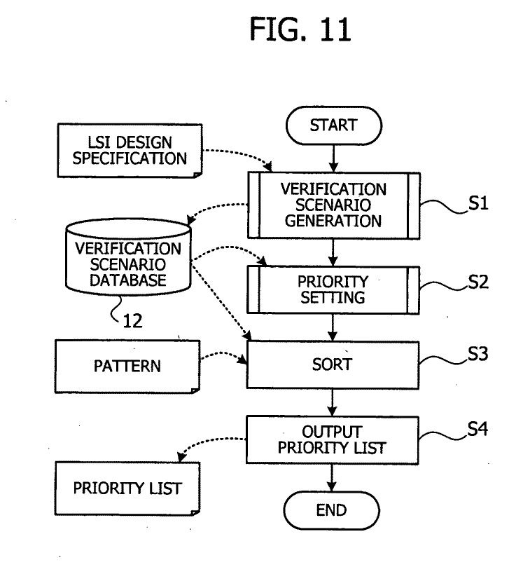

Referring now to the flowchart of FIG. 11, the following description will give a general view of what the design verification apparatus 10 performs.

At the outset, the verification scenario generator 11 executes a process of verification scenario generation on the basis of an LSI design specification 20 specified by the user, so as to generate verification scenarios (step S1). The generated verification scenarios are saved in the verification scenario database 12. Subsequently the priority setter 13 executes a priority setting process based on a user-specified pattern, thus assigning priorities to the verification scenarios stored in the verification scenario database 12 (step S2). The output processor 14 sorts those verification scenarios according to the assigned priorities (step S3). Finally, the output processor 14 compiles a list of the names of prioritized verification scenarios and outputs it as a priority list (step S4).

The above series of steps may include some interaction with the user. For example, the verification scenario generator 11 may generate verification scenarios beforehand and save the result in the verification scenario database 12. The design verification apparatus 10 then waits for entry of a pattern from the user before starting verification scenario generation.

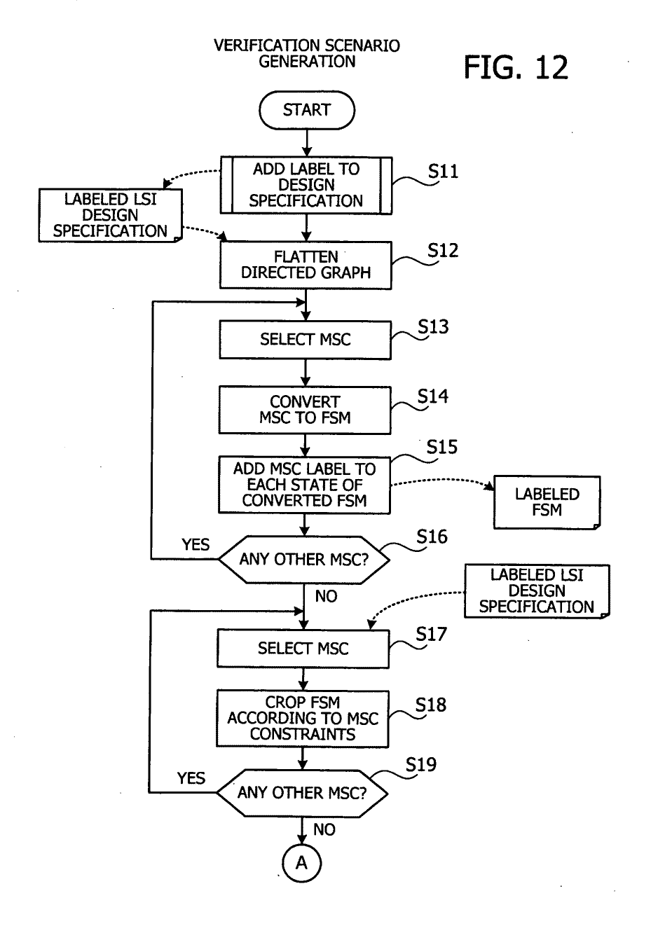

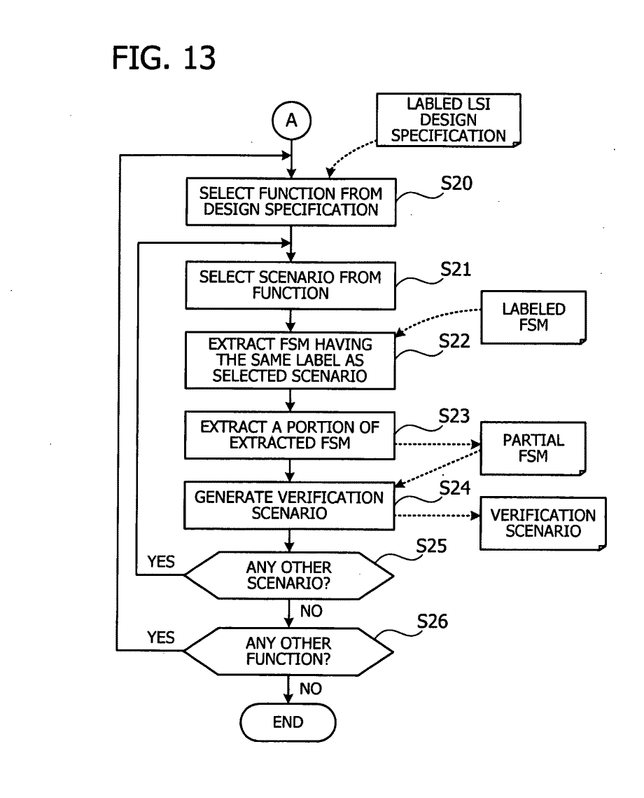

Referring now to the flowchart of FIGS. 12 and 13, the following will provide details of the verification scenario generation process called at step S1. This process proceeds as follows:

The verification scenario generation process first calls another process to add labels to the LSI design specification 20 (step S11). Details of this labeling process will be described later with reference to another flowchart. The process then flattens, or removes hierarchical structure from, a directed graph of the labeled LSI design specification (step S12). Out of the flattened directed graph, the process selects one message sequence chart (step S13) and converts the selected message sequence chart into a finite state machine (FSM) (step S14). As a result this step, data event messages exchanged in a series of message sequence charts are expressed as a finite state machine, as will be described in detail later. The process adds a label to each state of the finite state machine (step S15). This label is what has the currently selected message sequence chart has gained at step S11. Through the processing at steps S14 and S15, the finite state machine obtains labels with its states. The verification scenario generator 11 saves the resulting labeled finite state machine in its local temporary memory.

It is then determined whether there is any other message sequence chart that awaits processing (step S16). If there is such an unselected message sequence chart (YES at step S16), the process returns to step S13 to select it and executes subsequent steps S14 and S15 with that newly selected message sequence chart.

If no unselected message sequence charts are found (NO at step S16), the process consults the labeled design specification saved in step S11 and selects therefrom one message sequence chart (step S17). The selected message sequence chart may contain some constraints (e.g., synch, timeout). According to such constraints, the process crops the finite state machine by removing unnecessary states found from the selected message sequence chart (step S18). Details of this step will be described later.

It is then determined whether there is any other message sequence chart that awaits processing (step S19). If there is found an unselected message sequence chart (YES at step S19), the process returns to step S17 to select it and executes subsequent step S18 with that newly selected message sequence chart.

If no unselected message sequence charts are found (NO at step S19), the process selects a function out of those defined in the labeled design specification of step S11 (step S20 in FIG. 13). The process then selects a scenario from the selected function (step S21) and extracts, from the labeled finite state machines produced at step S15, a finite state machine having the same label as the selected scenario (step S22). The process further extracts a portion of the finite state machine extracted at step S22, which is referred to as a “partial finite state machine” (step S23). The verification scenario generator 11 saves the extracted partial finite state machine in its temporary memory. The process then generates a verification scenario from the partial finite state machine of step S23 and enters it to the verification scenario database 12 (step S24), as will be described in detail later.

It is determined whether there is any other scenario in the function selected at step S20 (step S25). If there is such an unselected scenario (YES at step S16), the process returns to step S21 to select it and executes subsequent steps S22 and S24 with that newly selected scenario. If no unselected scenarios are found (NO at step S20), then the process determines whether there is any other function that awaits processing (step S26). If there is such an unselected function (YES at step S26), the process returns to step S20 to select it and executes subsequent steps S21 to S25 with that newly selected function. If no unselected function are found (NO at step S26), the verification scenario generation process terminates itself.

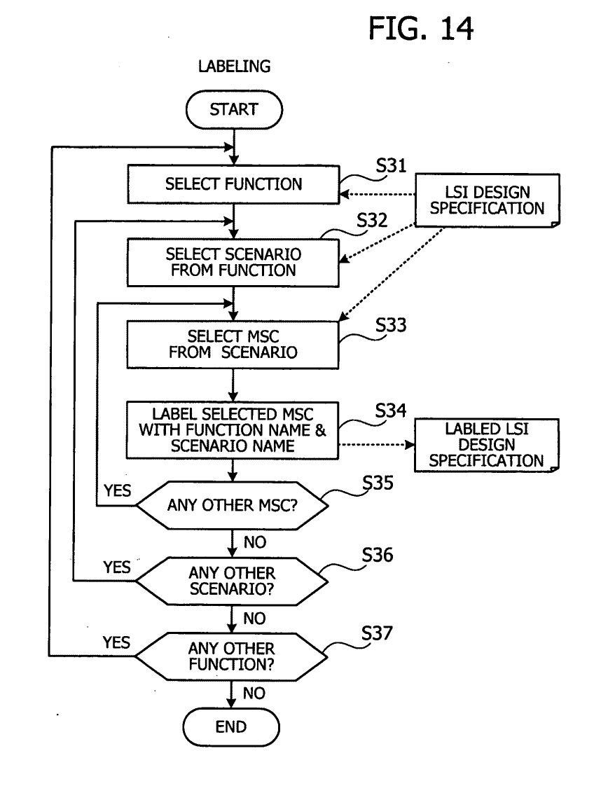

Referring now to the flowchart of FIG. 14, the following will provide details of the labeling process executed at step S11 (FIG. 12). This process proceeds as follows:

The labeling process first selects a function from those defined in a given LSI design specification (step S31) and then selects a scenario out of the selected function (step S32). The process further selects a message sequence chart in the selected scenario (step S33). The process adds a label to this message sequence chart (step S34), which includes the function name of the currently selected function (i.e., the one selected at step S31) and the scenario name of the currently selected scenario (i.e., the one selected at step S32). In the case where the message sequence chart has an existing label, that label is updated with the additional label (in other words, the message sequence chart now has two labels). The label may also include a message sequence chart name, in addition to the above-noted function name and scenario name.

The process now looks into the currently selected scenario to determine whether there is any other message sequence chart that awaits processing (step S35). If there is found such an unselected message sequence chart in the scenario (YES at step S35), the process returns to step S33 to select it and executes subsequent step S34 with the newly selected message sequence chart. If no unselected scenarios are found (NO at step S35), then the process determines whether there is any other scenario that awaits processing (step S36). If there is such an unselected scenario (YES at step S36), the process returns to step S32 to select it and executes subsequent steps S33 to S35 with that newly selected scenario. If no unselected scenarios are found (NO at step S36), then the process determines whether there is any other function that awaits processing (step S37). If there is such an unselected function (YES at step S37), the process returns to step S31 to select it and executes subsequent steps S32 to S36 with that newly selected function. If no unselected functions are found (NO at step S37), then the current labeling process terminates itself.

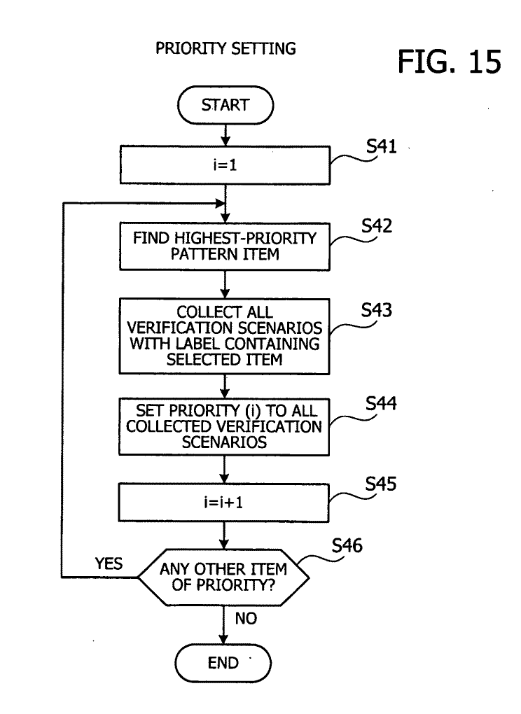

Referring now to the flowchart of FIG. 15, the following will provide details of the priority setting process called at step S2 of FIG. 11. With a given pattern, this process proceeds as follows:

At the outset, the process initializes parameter i to 1 (step S41). Then out of the items available in the given pattern, the process selects an item with the highest priority level (step S42). Suppose, for example, that the pattern specifies priorities as “Primary>Exceptional.” The process thus selects the item “Primary” in the first place.

The selected pattern item may be found in the labels of some verification scenarios. The process then collects all verification scenarios that have such matching labels in all of their states (step S43). Those verification scenarios are assigned a priority level of i (step S44). The process then increments parameter i by one (step S45) and determines whether there are any other items in the given pattern (step S46). If there are such remaining items (YES at step S46), the process returns to step S42 to select one with the highest priority and executes subsequent steps S43 to S45 with that newly selected item. If no items remain (NO at step S45), the priority setting process terminates itself.

(e) Example of Labeling Process

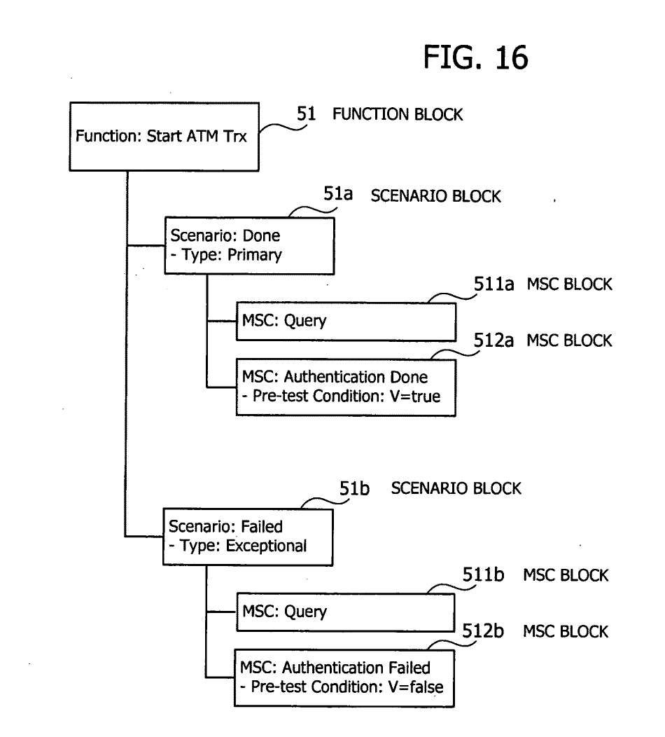

This section describes a specific example of labeling, with reference to a data structure of a specific LSI design specification illustrated in FIG. 16. The illustrated LSI design specification 20 is directed to transactions on an automatic teller machine (ATM). This example design specification provides a simplified description of authentication of prospect ATM users through the use of their ATM cards and personal identification numbers (PINS).

Specifically, the LSI design specification 20 of FIG. 16 includes a function block 51 that includes two scenarios describing functions for starting an ATM transaction. The first scenario relates to the function of the function block 51, a scenario represented by a scenario block 51a, and a path for starting and driving a verification scenario to implement the processing scenario of scenario block 51a. This first scenario will be implemented by using message sequence charts corresponding to two MSC blocks 511a and 512a. The first scenario is also associated with an ATM that is supposed to receive PIN from a prospect user.

The second scenario relates to the function of the function block 51, a scenario represented by a scenario block 51b, and a path for starting and driving a verification scenario to implement the processing scenario of scenario block 51b. This second scenario will be implemented by using message sequence charts corresponding to two MSC blocks 511b and 512b. The second scenario is also associated with an ATM that is supposed to receive PIN from prospect users. The following description will refer to the first scenario as scenario “Done” and the second scenario as scenario “Failed.”

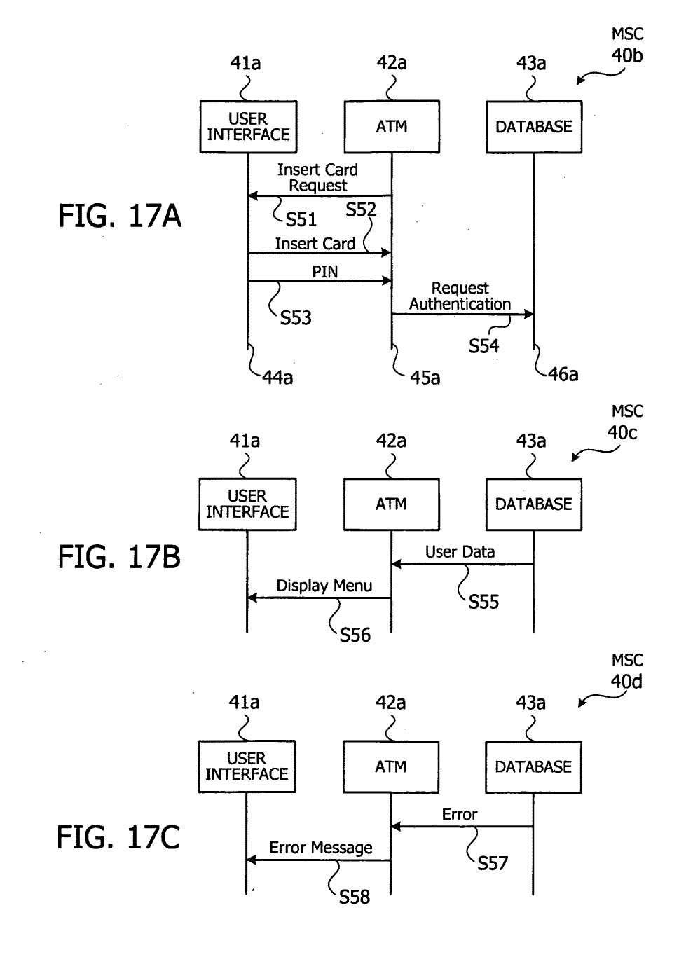

FIGS. 17A to 17C illustrate specific examples of message sequence charts which correspond to different verification scenarios. Referring first to FIG. 17A, a message sequence chart 40b corresponding to the MSC block 511a is depicted. As the MSC block 511a is identified by its identifier “Query,” the message sequence chart 40b is also referred to by the name of “Query.” Objects involved in the message sequence chart 40b are a user interface 41a, ATM 42a, and database 43a. These objects have their respective object lines, i.e., user interface line 44a, ATM line 45a, and database line 46a.

Based on the foregoing rules, the message sequence chart 40b gives the following process: At the outset, the ATM 42a transmits a card insertion request message (Insert_Card) to the user interface 41a (step S51). Upon receipt of this message, the user interface 41a sends a card insertion indication message (Card_Inserted) back to the ATM 42a (step S52). The user interface 41a subsequently transmits an entered password (PIN) to the ATM 42a (step S53). Upon receipt of the password, the ATM 42a transmits an authentication request (PIN_verify) message to the database 43a (step S54).

Referring now to FIG. 17B, a message sequence chart 40c corresponding to another MSC block 512a is depicted. As the MSC block 512a is identified by its identifier “Authentication Done,” this message sequence chart 40c is also referred to by the name of “Authentication Done.” The message sequence chart 40c involves the objects of user interface 41a, ATM 42a, and database 43a, as in the foregoing message sequence chart 40b.

Based on the foregoing rules, the message sequence chart 40c gives the following process: The database 43a sends user data to the ATM 42a (step S55). Upon receipt of this user data, the ATM 42a send a display menu message to the user interface 41a (step S56).

Referring then to FIG. 17C, a message sequence chart 40d corresponding to yet another MSC block 512b is depicted. As the MSC block 512b is identified by its identifier “Authentication Failed,” this message sequence chart 40d is also referred to by the name of “Authentication Failed.” The message sequence chart 40d involves the objects of user interface 41a, ATM 42a, and database 43a, as in the foregoing message sequence charts 40b and 40c.

Based on the foregoing rules, the message sequence chart 40d gives the following process: The database 43a returns an error to the ATM 42a (step S57). Upon receipt of this error, the ATM 42a sends an error message to the user interface 41a (step S58).

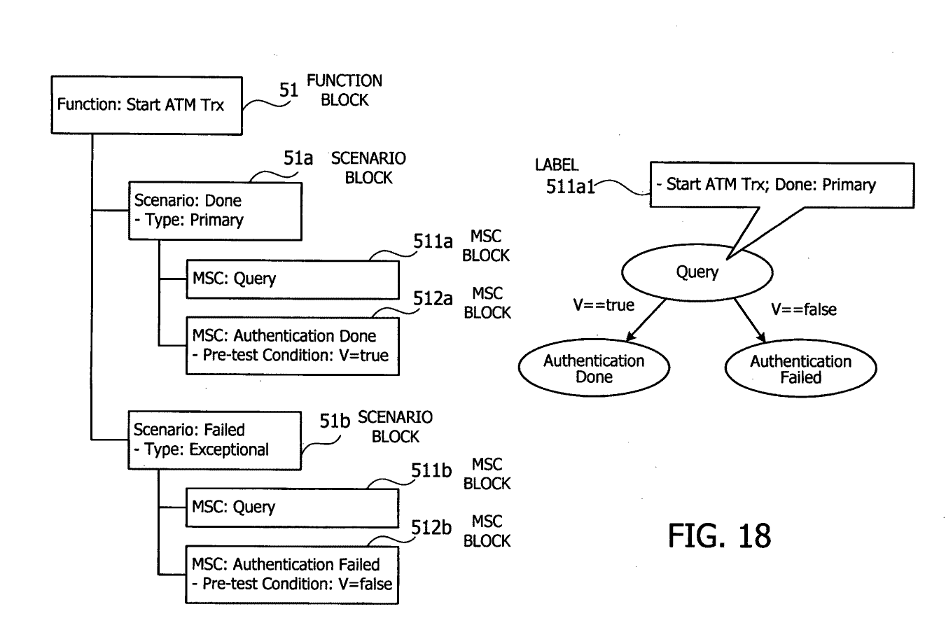

FIG. 18 to FIG. 20 give a specific example process of labeling an LSI design specification. The labeling process first consults the LSI design specification 20 and selects a function named “Start ATM Transaction” (shortened as “Start ATM Trx” where appropriate) of the function block 51. Out of the selected function, the process then selects scenario “Done” of the scenario block 51a. The process now selects “Query,” one of the two message sequence charts associated with the selected scenario, and adds a label to the selected message sequence chart “Query.” As described earlier, labels are supposed to include the names of currently selected function and scenario in the form of “function name; scenario name: scenario type.” Accordingly, in the example of FIG. 18, the message sequence chart “Query” is added a label 511a1 that reads: “Start ATM Trx; Done: Primary.” This is what is seen in FIG. 18.

The process then examines the present scenario block 51a to determine whether there is any unselected message sequence chart. The process thus discovers and selects an unselected message sequence chart “Authentication Done.” Accordingly, the process adds a label 512a1 of “Start ATM Trx; Done: Primary” to the currently selected message sequence chart “Authentication Done.”

The process determines again whether there is any unselected message sequence chart in the scenario block 51a. As this test returns a negative result, the process then goes back to the function block 51 to see whether there is any unselected scenario. The process thus discovers and selects an unselected scenario “Failed” of scenario block 51b.

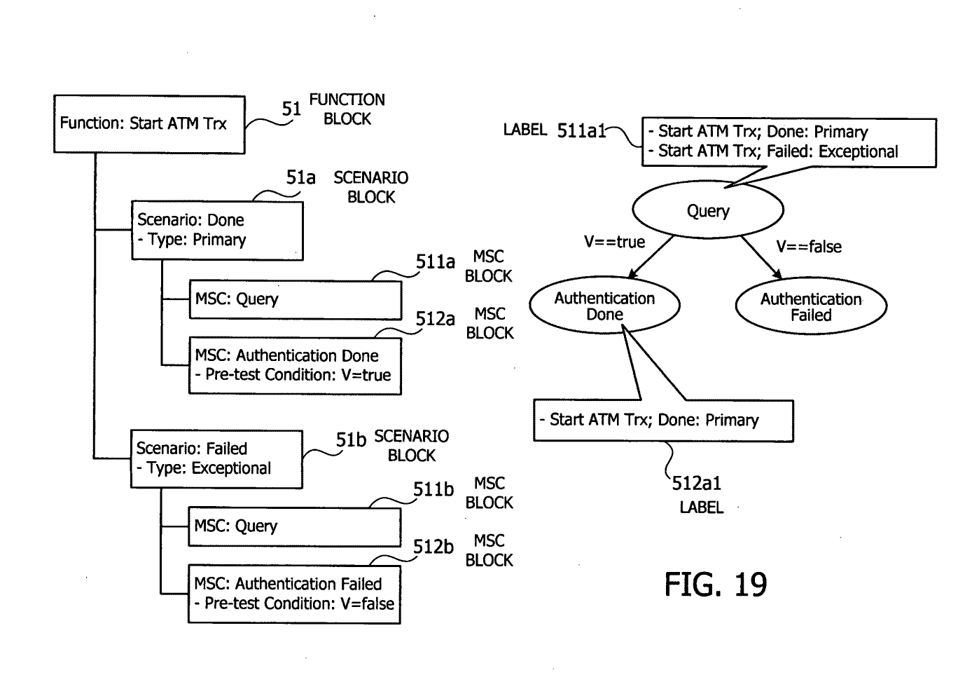

The process now selects “Query,” one of the two message sequence charts associated with the selected scenario, and adds a label to the selected message sequence chart “Query.” Since message sequence chart “Query” has an existing label 511a1, the labeling process updates that label 511a1 with an additional line of “Start ATM Trx; Failed: Exceptional.” FIG. 19 depicts processing results up to this point.

The process then examines the present scenario to determine whether there is any unselected message sequence chart. The process discovers and selects an unselected message sequence chart “Authentication Failed” and thus adds a label 512b1 which reads: “Start ATM Trx; Failed: Exceptional.”

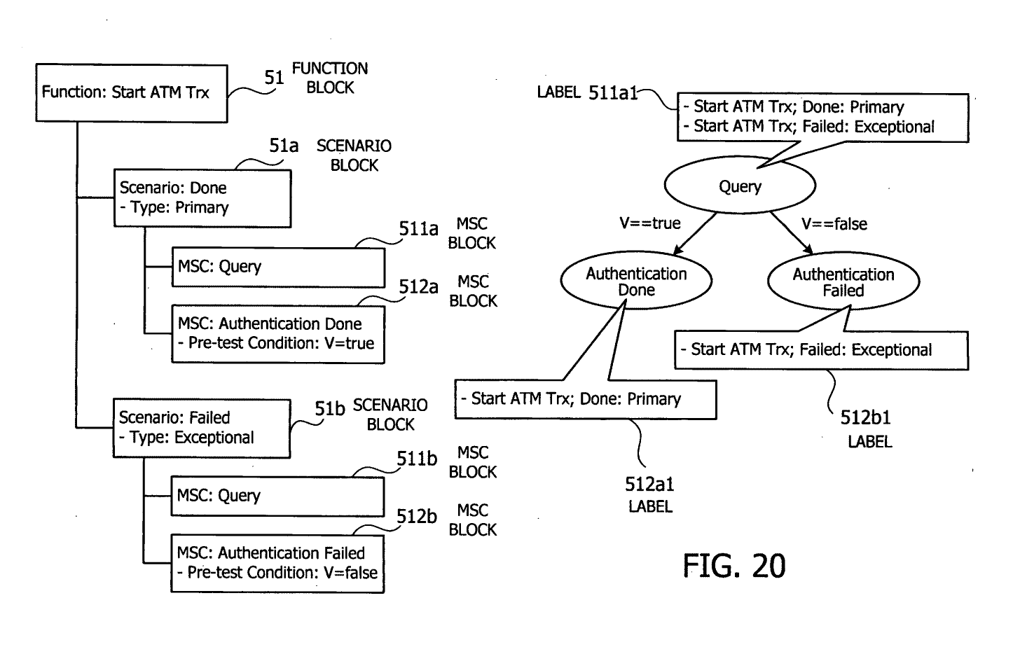

The process determines again whether there is any unselected message sequence chart in the scenario block 51b. As this test returns a negative result, the process then goes back to the function block 51 to see whether there is any unselected scenario. Since there is no more scenario, the current labeling process terminates itself. FIG. 20 depicts processing results up to this point.

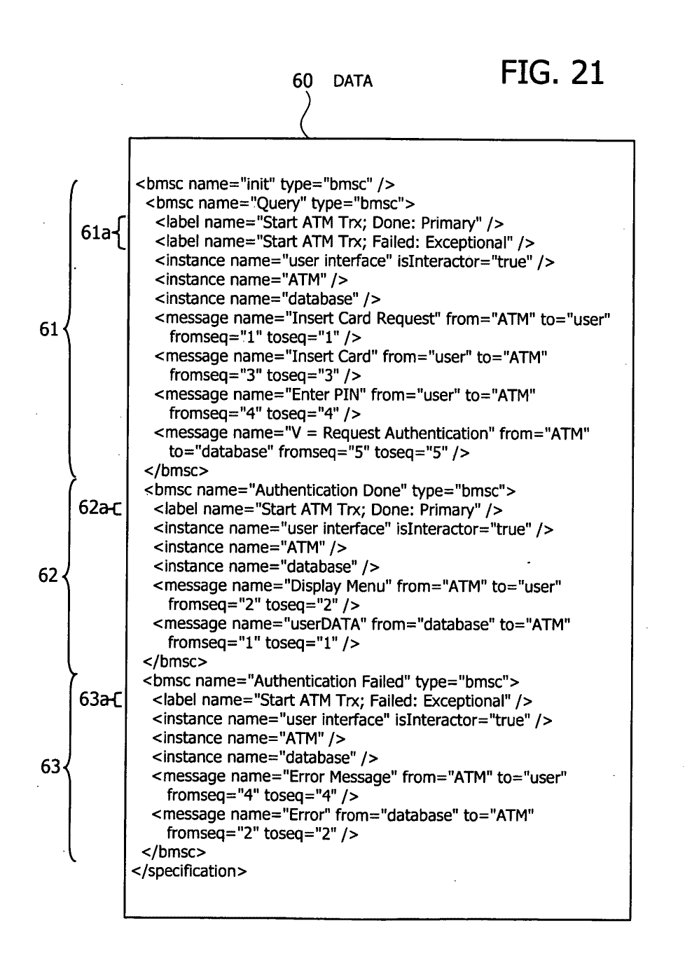

FIG. 21 illustrates a data structure of a labeled LSI design specification. The illustrated data 60 describes a labeled version of the LSI design specification 20 in the XML format. This data 60 is formed from three parts of descriptions 61, 62, and 63. The first description 61 describes a message sequence chart 40b (FIG. 17). The second description 62 describes another message sequence chart 40c (FIG. 17). The third description 63 describes yet another message sequence chart 40d (FIG. 17).

The descriptions 61, 62, and 63 include new lines 61a, 62a, and 63a, respectively. Those lines have been added by the foregoing labeling process, as indicated by the XML tag <label name>. This XML tag means that the line defines a label.

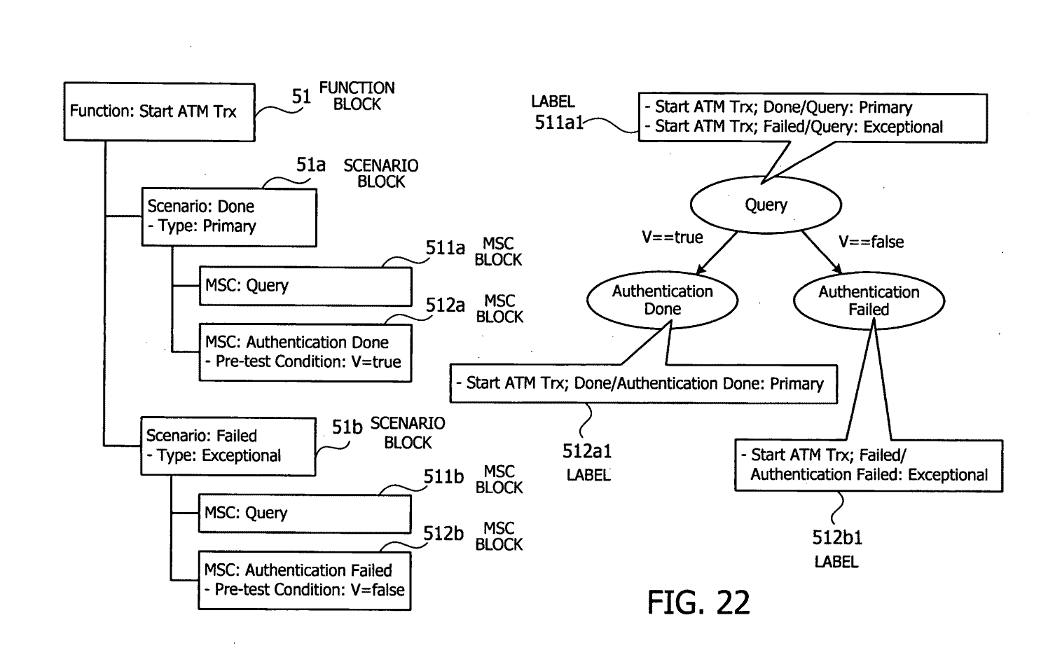

These labels may contain the name of message sequence chart, in addition to what is given in the form of “function name; scenario name: scenario type.” This additional label value permits the user to specify a priority pattern by using MSC names. FIG. 22 gives an example of such labels. Specifically, the illustrated labels 511a1, 512a1, and 512b1 contain the name of a corresponding message sequence chart in addition to the function name, scenario name, and scenario type.

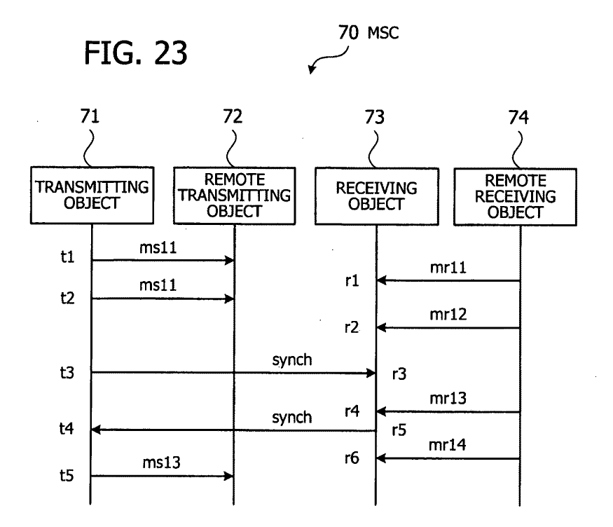

Referring now to the message sequence chart of FIG. 23, the following will provide details of step S14 (FIG. 12). As mentioned earlier, step S14 converts a message sequence chart into a finite state machine. To turn a directed graph into a finite state machine, the process of step S14 determines each state of the finite state machine by using events defined in each message sequence chart that the directed graph provides. Here, a message sequence chart defines the order of possible events, and each completed event of an object corresponds to a state of the finite state machine. The initial state, for example, corresponds to an event that is never completed in any objects. The final state corresponds to all events that have been completed in the objects.

Referring to FIG. 23, each part of the message sequence chart 70 will be reflected in the target finite state machine through a collection of events that occur to a part of objects. The objects illustrated in FIG. 23 are: a transmitting object 71, a remote transmitting object 72, a receiving object 73, and a remote receiving object 74. For example, one finite state machine is generated from the transmitting object 71 and receiving object 73. As can be seen in FIG. 23, the transmitting object 71 has five transmit events t1 to t5, while the receiving object 73 has six receive events r1 to r6. Here the transmitting object 71 is associated with the receiving object 73 by two synchronization edges (synch), without actually exchanging messages.

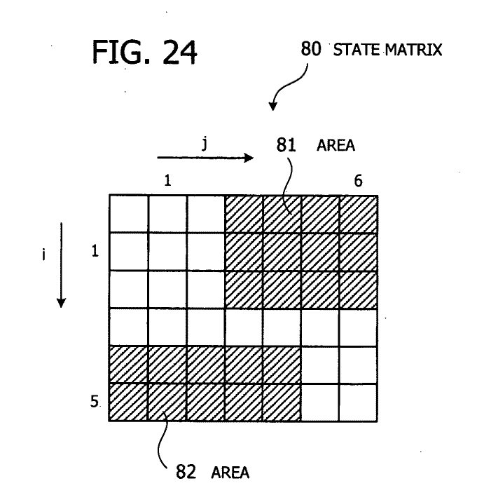

FIG. 24 illustrates a state matrix corresponding to the message sequence chart 70 of FIG. 23. This state matrix 80 will be used to further explain how to generate a finite state machine.

For illustrative purposes, suppose that there are only two objects 71 and 73 in the message sequence chart 70. The finite state machine can then be visualized as a two-dimensional state matrix 80. Each block of this state matrix 80 represents a state in which the transmitting object 71 has completed a specific transmit event ti and the receiving object 73 has completed a specific receive event rj. In other words, block (i, j) represents state (ti, rj).

The state matrix 80 has its origin at the top-left corner, and the inverted-T symbol “⊥” is used to indicate an initial state. As the initial state is located at the top-left corner of the state matrix 80, state transitions take place in the direction to the bottom-right corner. The bottom-right corner of this state matrix 80 thus represents the final state.

When the transmitting object 71 and receiving object 73 have no synchronization edges between them, their state matrix 80 will be a fully-populated (n×m) state matrix, where n is the number of messages transmitted from the transmitting object 71, and m is the number of messages received by the receiving object 73. The presence of synchronization edges in the message sequence chart 70 reduces the number of effective states in the corresponding state matrix 80. That is, a synchronization edge nullifies some states in the state matrix 80, and it is possible to cross out such ineffective states.

Transmit event t3 corresponds to a synchronization edge extending from the transmitting object 71 to the receiving object 73. Reception event r3 is associated with that synchronization edge in this case. Every event occurring in the receiving object 73 after the receive event r2 should not precede the transmit event t3. Accordingly, receive events r3 to r6 are not allowed to happen before the transmit event t3. Based on this fact of the objects 71 and 73, the generation process crosses out an ineffective area 81 of the state matrix 80. Another ineffective area 82 corresponding to the second synchronization edge is crossed out similarly.

The remaining area of the state matrix 80 represents exactly the message sequence chart 70. For example, state t2 refers to a state of the transmitting object 71 when it has finished transmit event t2. State r1 refers to a state of the receiving object 73 when it has finished receive event r1.

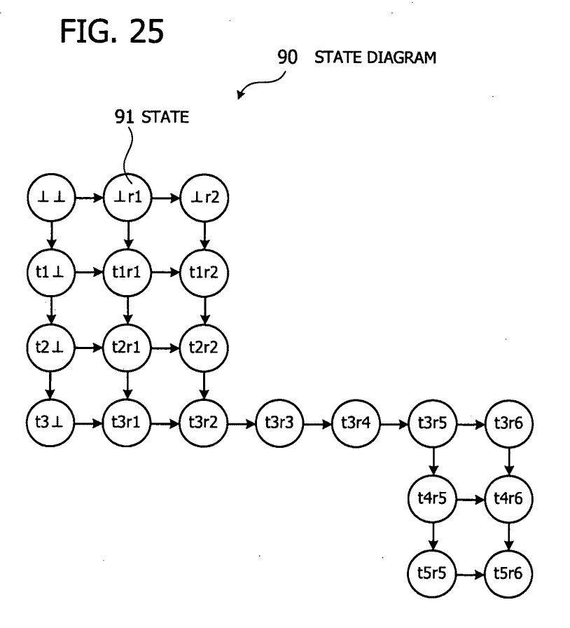

FIG. 25 is a state diagram corresponding to the state matrix 80. State 91 is one of the states in the illustrated state diagram 90. This state 91 corresponds to one block of the state matrix 80 discussed in FIG. 24. A value of state is indicated in each symbol of state (i.e., circles in FIG. 25). In the illustrated state diagram 90, a state transition in the horizontal direction corresponds to reception of a message. This is implemented in a finite state machine as transmission of a message. Likewise, a state transition in the vertical direction corresponds to transmission of a message. This is implemented in a finite state machine as a state awaiting a message.

When it is possible to move from the current state (i, j) to a new state in either of the horizontal and vertical directions, a horizontal transition is fired by transmitting a certain message. This is attempted depending on whether a message invoking a vertical direction is subsequently received. If that test result is positive, a vertical transition may also take place, in which case the next state will be (i+1, j+1). If the test result is negative, the transition will only happen in the horizontal direction, from (i, j) to (i+1, j).

For an object awaiting a message, a timer is employed during its message-waiting state in order not to let the object wait for an expected message endlessly. The timer terminates the waiting state upon expiration of an appropriate time.

Some states may allow either a vertical transition or a horizontal transition, but not both. For such states, the finite state machine only implements their applicable transitions.

As can be seen from the above, the direction of transition is one parameter that affects generation of finite state machines. Another such parameter is a particular type of events related to the state. Take the transmitting object 71 and receiving object 73 in FIG. 23, for example. The transmitting object 71 has several events on its object line, each of which falls in either of the following three categories: message transmit events, timer start events, and timeout signal receive events. Similarly, the receiving object 73 has several events which fall in either of the following three categories: message receive events, timer start events, and timeout signal receive events. These variations of event types in each object lead to nine possible combinations of states which should be considered when generating a finite state machine, since the code produced for each node of the machine depends on exact combinations of such states.

With the above-described techniques, finite state machines are generated from given message sequence charts. Specifically, to produce finite state machines corresponding to different scenarios, the generation process traces a specified path of each scenario. The process generates a finite state machine for each message sequence chart encountered on the path. The final state of one message sequence chart is linked to the first state of the next message sequence chart on the path. If necessary, the resulting finite state machines may be combined into a single machine.

Finite state machines can be generated and edited automatically by combining all signals and variable declarations. The resulting finite state machine can then be used to simulate operation of the device 300 under test.

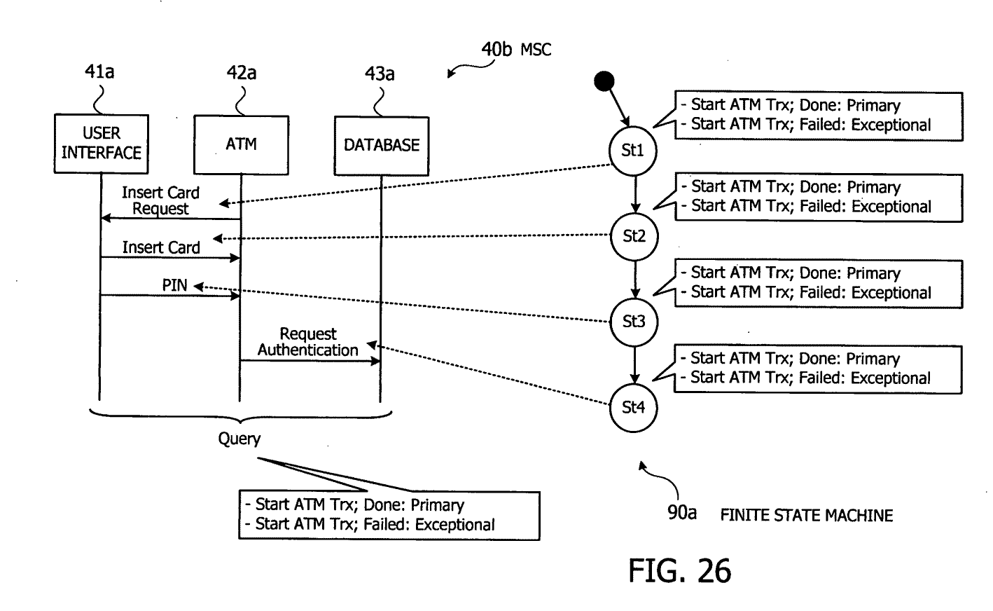

Referring now to FIG. 26, the following description will discuss a specific example of how the process of step S15 adds labels to a finite state machine.

Using the foregoing method, the process produces a finite state machine with states corresponding to data event messages in a given message sequence chart. Each machine state is then labeled with the labels of that source message sequence chart. In the present example, four machine states St1, St2, St3, and St4 have been produced from a message sequence chart “Query” as can be seen in FIG. 26. This message sequence chart “Query” bears the following two labels:

“Start ATM Trx; Done: Primary”

“Start ATM Trx; Failed: Exceptional”

Accordingly, every state St1, St2, St3, and St4 of the finite state machine is equally given these labels.

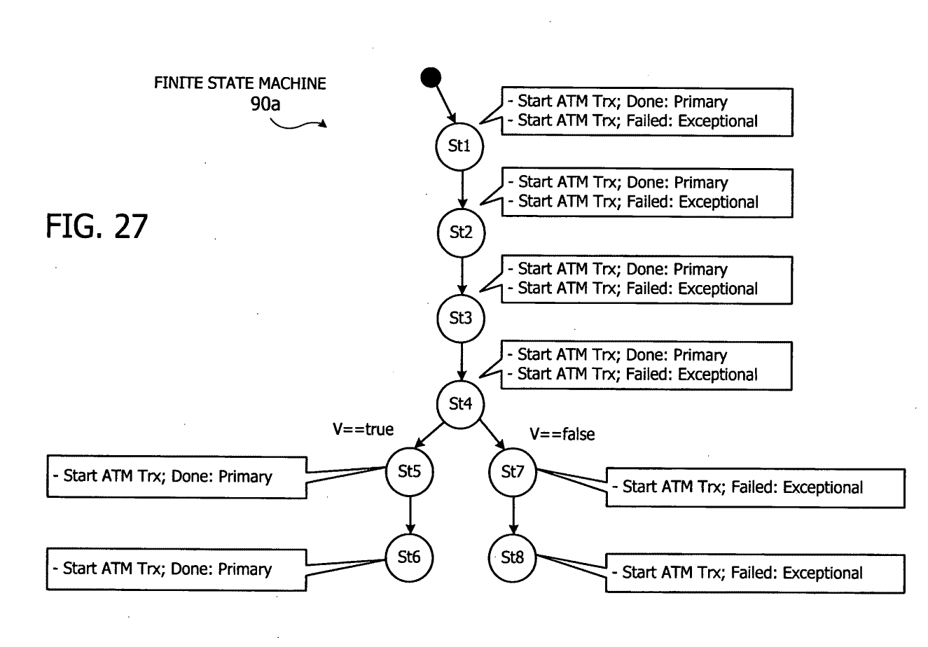

FIG. 27 depicts a final view of the labeled finite state machine. The finite state machine now has states St5 and St6, which have been produced from another message sequence chart “Authentication Done.” Since the original message sequence chart “Authentication Done” has a label of “Start ATM Trx; Done: Primary,” each state St5 and St6 has that same label.

The finite state machine of FIG. 27 has also gained additional states St7 and St8 from yet another message sequence chart “Authentication Failed.” Since the original message sequence chart “Authentication Failed” has a label of “Start ATM Trx; Failed: Exceptional,” each state St7 and St8 has that same label.

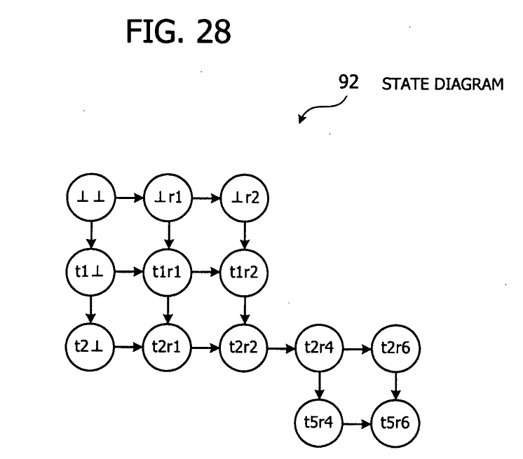

Referring now to FIG. 28, the following description will discuss a specific example of how the process of step S18 crops the finite state machine according to constraints of a given message sequence chart.

FIG. 28 is a state diagram 92 corresponding to the state matrix 80 (FIG. 24). Synchronization events may be removed from the state diagram 90 (FIG. 25) since they are only used to partly limit the order of actual operation events according to some constraint of other devices or external entities. Removal of such synchronization events yields a simplified state diagram 92 as depicted in FIG. 28.

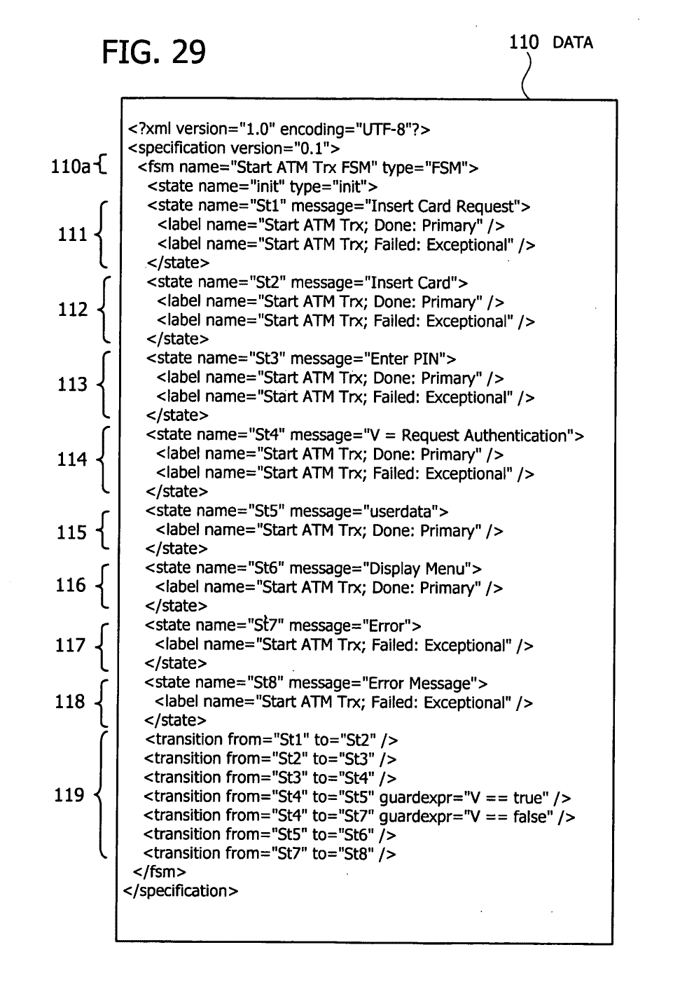

FIG. 29 illustrates an example data structure of a finite state machine. The illustrated data 110 describes a finite state machine in the XML format, which is formed from a plurality of descriptions 110a and 111 to 119. Description 110a gives an identifier of the finite state machine 90a (FIG. 27) in a finite state machine tag <fsm name> indicating that what is described in the data 110 is a finite state machine. The contents of each tag derive from the corresponding labels added to the finite state machine. Descriptions 111 to 118 correspond to states St1 to St8, respectively. Description 119 describes transitions between those states St1 to St8.

Referring to the LSI design specification 20 of FIG. 16 and the labeled finite state machine 90a of FIG. 27, the following description will provide a specific example of how a verification scenario is generated from each processing scenario.

The generation process first consults the design specification of FIG. 16 and selects a function “Start ATM Trx” of the function block, 51. The process further selects a scenario “Done” out of the selected function and extracts a finite state machine that contains “Done” in its labels. Specifically, the finite state machine illustrated in FIG. 27 is extracted.

The process further extracts a portion of the finite state machine that bears the same label as the selected scenario. As can be seen from FIG. 27, the selected scenario “Done” has a label of “Start ATM Trx; Done: Primary.” Accordingly, the process extracts a collection of states St1 to St6 from the finite state machine. The extracted partial finite state machine is then saved in the verification scenario database 12 as a verification scenario for the purpose of testing the selected scenario “Done” of the design specification.

The process now determines whether there is any other scenario in the selected function, thus finding another scenario “Failed.” Accordingly, the process selects that scenario “Failed” from the selected function “Start ATM Trx” and extracts a finite state machine that contains “Failed” in its labels. Specifically, the finite state machine illustrated in FIG. 27 is extracted.

The process further extracts a portion of the finite state machine that bears the same label as the selected scenario. As can be seen from. FIG. 27, the selected scenario “Failed” has a label of “Start ATM Trx; Failed: Exceptional.” Accordingly, the process extracts a collection of states St1, St2, St3, St4, St7, and St8 from the finite state machine. The extracted partial finite state machine is then saved in the verification scenario database 12 as a verification scenario for the purpose of testing the selected scenario “Failed” of the design specification.

The process determines again whether there is any other scenario in the selected function, only to find no unselected scenarios. The process also determines whether there is any other function in the design specification, only to find no unselected functions. The process thus terminates itself.

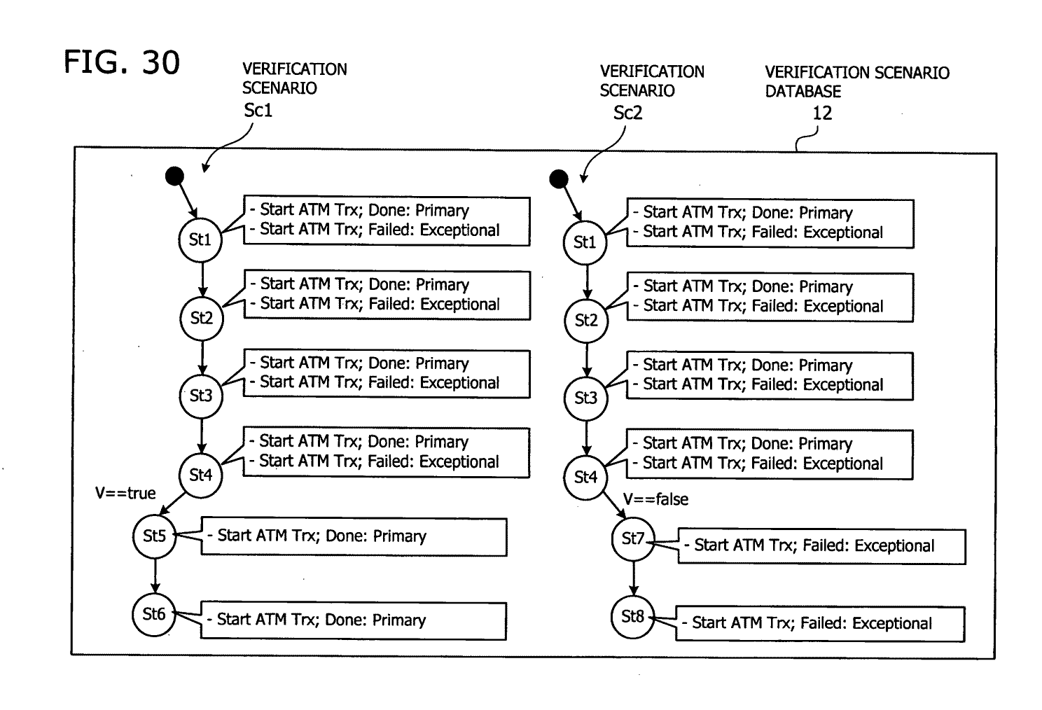

FIG. 30 illustrates verification scenarios stored in the verification scenario database 12. As can be seen in FIG. 30, there are two verification scenarios: Sc1 for testing a processing scenario “Done” and Sc2 for testing another processing scenario “Failed.” The next section (f) will provide more details of verification scenario generation, with a focus on how the process of step S24 produces a verification scenario from a given finite state machine.

(f) Verification Scenario Generation

As described above, verification scenarios are produced from partial finite state machines. While it was relatively easy in the foregoing examples, that is not always the case. For example, the verification scenario generator 11 may actually encounter a finite state machine containing a loop of states. In such cases, the verification scenario generator 11 may need to cut or divide a given partial finite state machine into several units in order to generate verification scenarios.

For example, a partial finite state machine may be cut into small units according to the presence of a state that appears in more than one path. Or alternatively, or in addition to that, a plurality of verification scenarios may be produced according to the constraint that at least a minimum number of, or at most a maximum number of states be present in each verification scenario.

Suppose, for example, that the following partial finite state machine has been extracted from the original machine:
St2-->St4-->St6-->St7-->St2-->St3-->St6-->St7-->St2-->St3-->St5-->St7-->St2-->St3-->St5-->St2.

One logic for dividing such a partial finite state machine is to cut the loop at a repetitively appearing state. In the present case, state St2 is where this long partial finite state machine will be cut into four verification scenarios as follows:

(1) St2-->St4-->St6-->St7

(2) St2-->St3-->St6-->St7

(3) St2-->St3-->St5-->St7

(4) St2-->St3-->St5-->St2

To produce a longer verification scenario, the verification scenario generator 11 is allowed to enforce a requirement that at least five states be included in each verification scenario, in addition to the use of St2 as a cutting point. These constraints result in the following two verification scenarios:

(5) St2-->St4-->St6-->St7-->St2-->St3-->St6-->St7

(6) St2-->St3-->St5-->St7-->St2-->St3-->St5-->St2

The verification scenarios generated in the above-described method are then subjected to a priority setting process as will be described below.

At the outset, the priority setting process initializes parameter i to 1. Then out of the items available in a given pattern, the process selects the one with the highest priority level. Suppose, for example, that the given pattern specifies “Primary>Exceptional” meaning that primary operation be selected in preference to exceptional operation. Accordingly, the process selects primary operation as a highest-priority item in the pattern.

The process then consults the verification scenario database 12 to collect all existing verification scenarios that have a label of “Primary” in every state. In the present example, verification scenario Sc1 is collected because Sc1 contains “Primary” in all states as can be seen from FIG. 30. The collected verification scenario Sc1 is given a priority level of “1” according to the current value of parameter i. Parameter i is then incremented to 2.

The process determines whether there is any other priority item in the given pattern, and thus finds a subsequent item “Exceptional.” The process consults the verification scenario database 12 to collect all existing verification scenarios that have a label of “Exceptional” in every state. In the present example, verification scenario Sc2 is collected because Sc2 contains “Exceptional” in all states as can be seen from FIG. 30. The collected verification scenario Sc2 is given a priority level of “2” according to the current value of parameter i. Parameter i is then incremented to 3, but the process terminates itself since no unselected priority item remains in the given pattern.

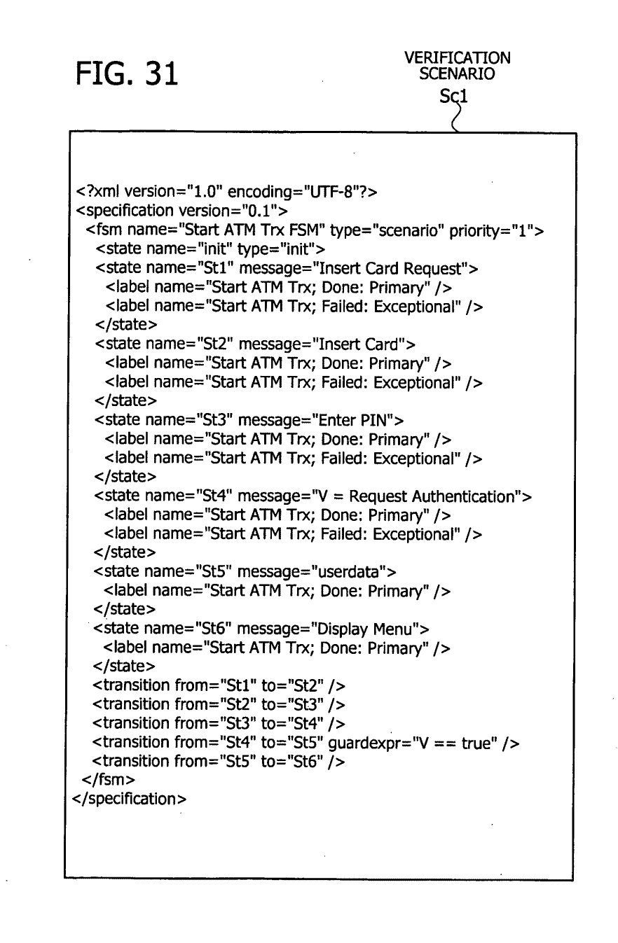

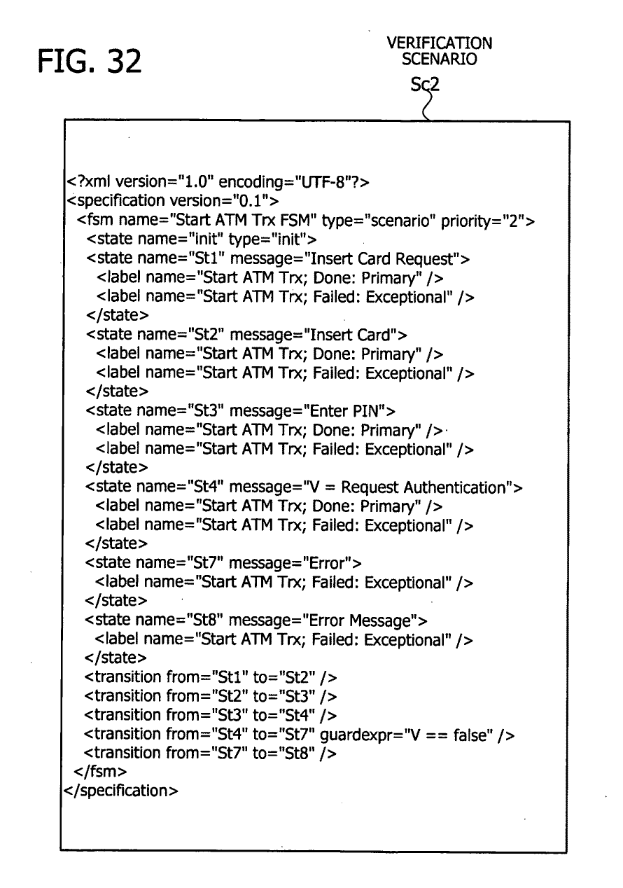

FIGS. 31 and 32 illustrate a data structure of prioritized verification scenarios. Specifically, FIG. 31 illustrates verification scenario Sc1. Line 3 of this verification scenario Sc1 reads: <fsm name=“Start ATM Trx FSM” type=“scenario” priority=“1”>. The second attribute type=“scenario” indicates that this document describes a verification scenario. The third attribute priority=“1” indicates that this verification scenario has a priority level of “1.”

FIG. 32 illustrates verification scenario Sc2. Line 3 of this verification scenario Sc2 reads: <fsm name=“Start ATM Trx FSM” type=“scenario” priority=“2”>. The second attribute type=“scenario” indicates that this document describes a verification scenario. The third attribute priority=“2” indicates that this verification scenario has a priority level of “2.”

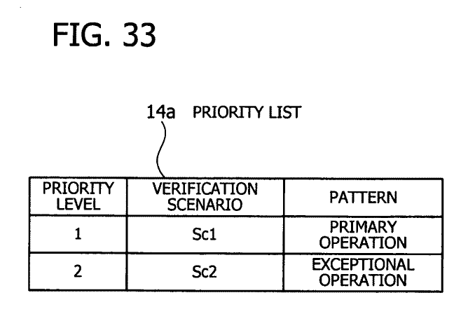

The names of the above verification scenarios are then compiled in a priority list as illustrated in FIG. 33. The illustrated priority list 14a has, among others, a PRIORITY LEVEL field and a VERIFICATION SCENARIO field. The PRIORITY LEVEL field contains a value indicating a specific priority level, while the VERIFICATION SCENARIO field contains the name of a corresponding verification scenario. In the present example, the first entry is of the foregoing verification scenario Sc1 with a priority level of “1,” and the second entry is of the foregoing verification scenario Sc2 with a priority level of “2.” The priority list 14a further provides a PATTERN field to indicate which pattern item was used out of those in a given pattern.

To summarize the above-described second embodiment, the proposed design verification apparatus 10 employs a verification scenario generator 11 to produce verification scenarios for a plurality of processing scenarios defined in a given LSI design specification 20 by assigning appropriate labels to message sequence charts of each processing scenario.

More specifically, the verification scenario generator 11 is designed to offer (but not limited by) the following features: First, the verification scenario generator 11 assigns labels to each message sequence chart, making it possible to identify which message sequence charts constitute a specific scenario. Also, the verification scenario generator 11 generates a finite state machine from such message sequence charts, where each state of the produced state machine is assigned the label of its corresponding message sequence chart. This feature makes it possible to identify what states are included in a single scenario. Furthermore, the verification scenario generator 11 extracts finite state machines corresponding to each processing scenario of the given LSI design specification 20, so that a verification scenario can be produced for each extracted finite state machine. These features make it possible to produce verification scenarios according to a given pattern (or depending on the stage of design and verification).

The design verification apparatus 10 also employs a priority setter 13 to prioritize verification scenarios according to a user-specified priority pattern, and an output processor 14 to output the prioritized verification scenarios, together with their processing order in a priority list 14a. These features permit the user to verify his/her design efficiently by executing scenarios in the described order.

The priority setter 13 is configured to apply a specific priority equally to all verification scenarios related to the portions specified by a given pattern. It is therefore possible to execute a verification test with required verification scenarios all at the same priority level. In other words, this feature aids the user to verify every necessary scenario without omission.

In addition, the priority setter 13 is configured to use process priority information included in a given pattern when determining priorities of verification scenarios. This feature provides the user with flexibility in specifying a pattern of process priorities. For example, priority patterns may include, but not limited to, the following pattern:

(1) In the early stage of verification, it is appropriate to verify primary paths in the first place, in preference to alternative paths and exceptional paths. Accordingly, the following pattern is preferable: “Primary>Alternative>Exceptional”

(2) In the case of a regression test after bug fixing, it is appropriate to give top priority to the scenario X where the bug was found and fixed and then verify other scenarios Y referencing directly to the fixed point before testing the remaining scenarios Z. Accordingly, a preferable pattern is in the following form: “scenario X>scenarios Y>scenarios Z”

(3) In the final stage of design, it is often desirable to concentrate on exceptional cases. It is therefore appropriate to test the exceptional path of scenarios in the first place and then proceed to alternative path and primary path. Accordingly, the following pattern is preferable: “Exceptional Alternative>Primary”

(4) The specification of the target product may be changed in the middle of its design process. If this is the case, it is appropriate to give priority to the scenarios relating to the modified functions. Accordingly, the pattern preferably specifies such scenarios alone.

In the context of design verification, a coverage-driven technique may be used to improve the efficiency of verification work. The coverage-driven verification previously defines several observable properties and an end condition of a verification session from given design data and continues verification until that condition is met. Typical properties include the number of lines and branches in the implementation of interest. Such coverage-driven approach is supported by some existing tools and reference books, such as Open Verification Methodology (OVM) and Verification Methodology Manual (VMM).

One approach to ensure the verification coverage of a practical level is to introduce several coverage bases for verification and combine their values to determine whether the present verification coverage is sufficient as a whole. Here the term “coverage base” refers to the metrics of test coverage. The coverage base may actually vary in a dynamic fashion, depending on the circumstances of LSI design or its verification. Such variations may be necessary when, for example, a software program is revised, or when the product specification is changed. Since those changes may bring about an unexpected result and thus necessitate a regression test to verify the current design.

In view of the above, the following third embodiment proposes a design verification apparatus which produces verification scenarios based on a given coverage base.

### Third Embodiment

This section will describe a system according to a third embodiment. Since the third embodiment shares several elements with the foregoing second embodiment, the following discussion will focus on their differences, not repeating explanation of similar elements.

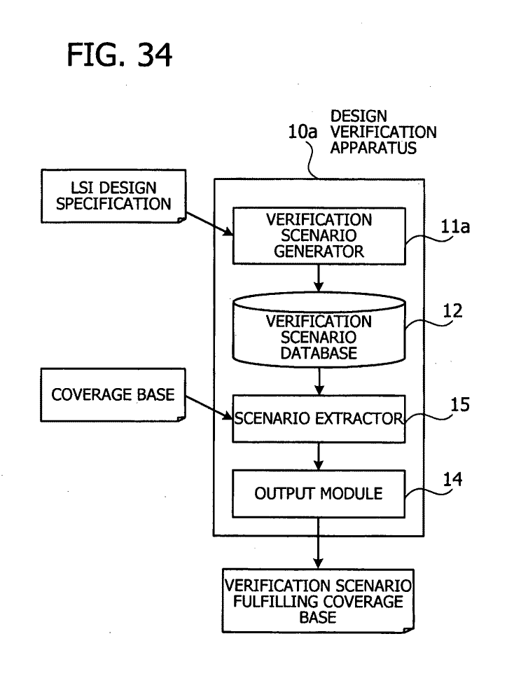

FIG. 34 is a block diagram illustrating a system according to the third embodiment. The illustrated system differs from the foregoing second embodiment in that the design verification apparatus 10a is configured to handle a change in the coverage base and thus capable of producing scenarios for verifying how the design is affected by that change.

Before defining a coverage base, it is necessary to define which metrics to use to express coverage. According to the present embodiment, the metrics are selected from what the LSI design specification 20 provides as measurable items, which may include (among others): functions, scenarios, scenario types, data event messages, a set of messages-sending object and message-receiving object, and other objects.

According to the present embodiment, functions are assumed to use every relevant scenario included in their definitions. The LSI design specification 20 may include various types of scenarios, and the present embodiment assumes that all types of scenarios are available for use. The present embodiment uses particular data event messages, which is equivalent to using every scenario including relevant messages. The present embodiment also assumes the use of every verification scenario including particular objects.

A coverage base may be defined as a logical expression formed from some metric elements. Such coverage bases can be fine-tuned by combining appropriate logical expressions of metric elements. Logical operators used for this purpose may include, but not limited to, AND, OR, NOT, NAND, and NOR.

According to the third embodiment, the design verification apparatus 10a employs a verification scenario generator 11a and a scenario extractor 15 in place of the verification scenario generator 11 and priority setter 13 of the second embodiment. Besides being similar to the verification scenario generator 11, the verification scenario generator 11a offers the function of producing labels that include the name of a message and its sending and receiving objects when it generates a verification scenario.

The scenario extractor 15 extracts verification scenarios from among those stored in the verification scenario database 12, so that the extracted verification scenarios will satisfy a given coverage base. The coverage base may be specified by the user, or may be selected from among those prepared by the user. The output processor 14 outputs a list of scenario names indicating the verification scenarios qualified by the scenario extractor 15 according to the coverage base.

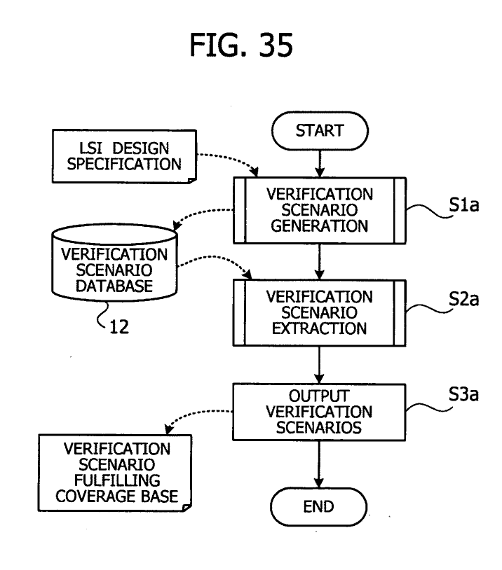

Referring now to the flowchart of FIG. 35, the following description will provide a general view of what is performed by the design verification apparatus of the third embodiment.

At the outset, the verification scenario generator 11a executes a process of verification scenario generation on the basis of an LSI design specification 20 specified by the user, thus generating verification scenarios (step Slay. The generated verification scenarios are then saved in the verification scenario database 12. The scenario extractor 15 executes a verification scenario extraction process (step S2a). Specifically, the scenario extractor 15 extracts verification scenarios fulfilling the given coverage base, out of those stored in the verification scenario database 12. Finally, the output processor 14 outputs the names of those extracted verification scenarios (step S3a).

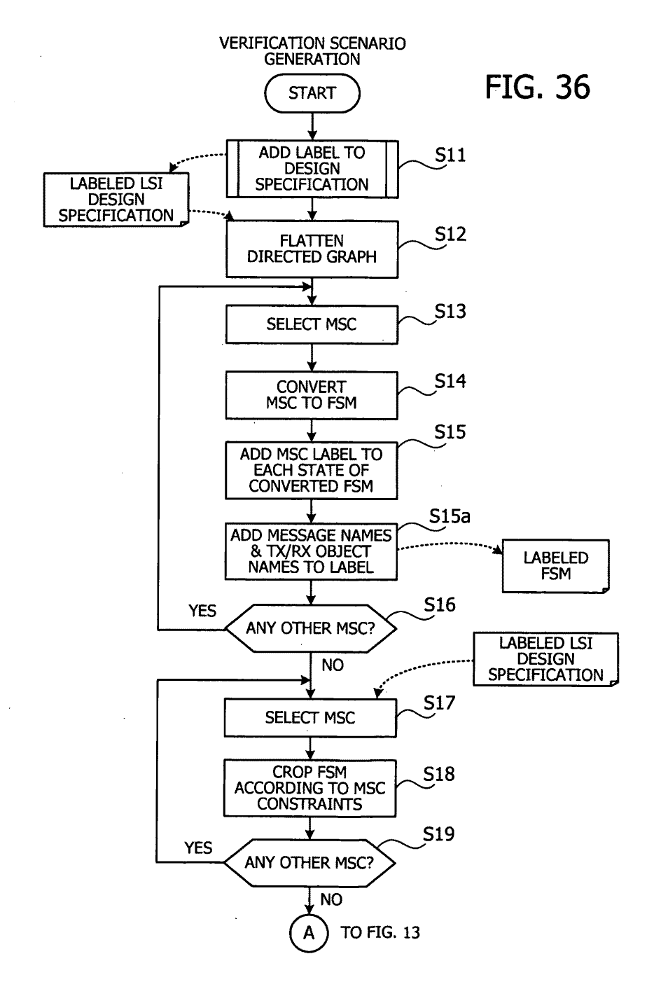

Referring now to the flowchart of FIG. 36, a verification scenario generation process of the third embodiment will be described below.

In steps S11 to S15, the verification scenario generation process operates in the same way as in the second embodiment. In step S15a, the process adds message names, transmit object names, and receive object names to relevant labels of a finite state machine. The process then proceeds to step S16 and executes subsequent steps S17 to S26 in the same way as in the second embodiment until the end of the process (see FIG. 13 for steps S20 to S26).

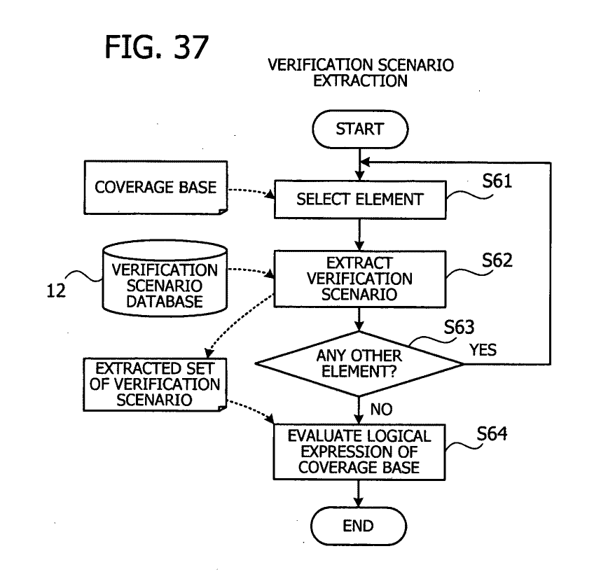

Referring next to the flowchart of FIG. 37, the verification scenario extraction of step S15a will be described below.

At the outset, this process selects an element of the given coverage base (step S61). Then, based on the selected coverage base, the process extracts qualified verification scenarios from among those stored in the verification scenario database 12 (step S62). It is then determined whether there is any other element of the coverage base (step S63).

If there is such an unselected element (YES at step S63), the process returns to step S61 to select it and executes subsequent step S62 with that newly selected element.

If no unselected elements are found (NO at step S63), then the process evaluates a logical expression of the coverage base for each set of extracted verification scenarios (step S64). That is, the process calculates a given logical expression (if present in the given coverage base) and sends its resulting value to the output processor 14. In the case where the coverage base is formed from a single element, the only set of verification scenarios extracted at step S62 is sent to the output processor 14. The extraction process then terminates itself.

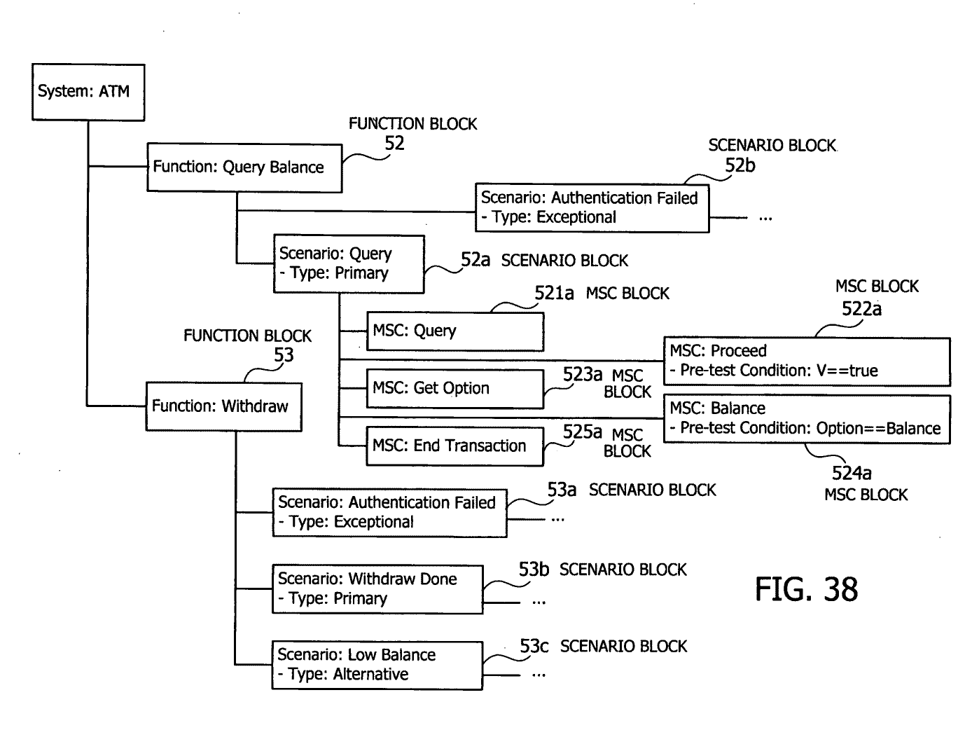

Referring now to FIG. 38 and subsequent drawings, the following description will provide a specific example to explain how the design verification apparatus 10a operates according to the third embodiment.

FIG. 38 illustrates an example data structure of an LSI design specification according to the third embodiment. One function block 52 is directed to a balance query function (“Query Balance”). Another function block 53 is directed to a cash withdrawal function (“Withdraw”). Specifically, the LSI design specification 20 of FIG. 38 provides five scenarios. The first scenario relates to a specific function presented in a function block 52, a specific scenario presented in a scenario block 52a, and a specific path for starting and driving a verification scenario to execute that scenario of scenario block 52a. This verification scenario will be implemented by using message sequence charts corresponding to five MSC blocks 521a to 525a. The first scenario is also associated with an ATM that is supposed to receive a password (PIN) from a prospect user.

The second scenario relates to a specific function presented in the function block 52, a specific scenario presented in a scenario block 52b, and a specific path for starting and driving a verification scenario to execute that scenario of scenario block 52b. The second scenario is also associated with an ATM that is supposed to decline entry of a password from a prospect user.

The third scenario relates to a specific function presented in a function block 53, a specific scenario presented in a scenario block 53a, and a specific path for starting and driving a verification scenario to execute that scenario of scenario block 53a. The third scenario is also associated with an ATM that is supposed to decline entry of a password from a prospect user.

The fourth scenario relates to a specific function presented in the function block 53, a specific scenario presented in a scenario block 53b, and a specific path for starting and driving a verification scenario to execute that scenario of scenario block 53b. The fourth scenario is also associated with an ATM that is supposed to accept entry of a password from a prospect user and display messages upon withdrawal of cash.

The fifth scenario relates to a specific function presented in the function block 53, a specific scenario presented in a scenario block 53c, and a specific path for starting and driving a verification scenario to execute that scenario of scenario block 53c. The fifth scenario is also associated with an ATM that is supposed to accept entry of a password from a prospect user and display a warning message indicating a low balance.

While not specifically illustrated in FIG. 38, the scenario blocks 52b, 53a, 53b, and 53c also have their respective MSC blocks.

The above-described first scenario will now be referred to as scenario “Query.” The second scenario will be referred to as scenario “Query Authentication Failed.” The third scenario will be referred to as scenario “Withdraw Authentication Failed”. The fourth scenario will be referred to as scenario “Withdraw Done”. The fifth scenario will be referred to as scenario “Low Balance”.

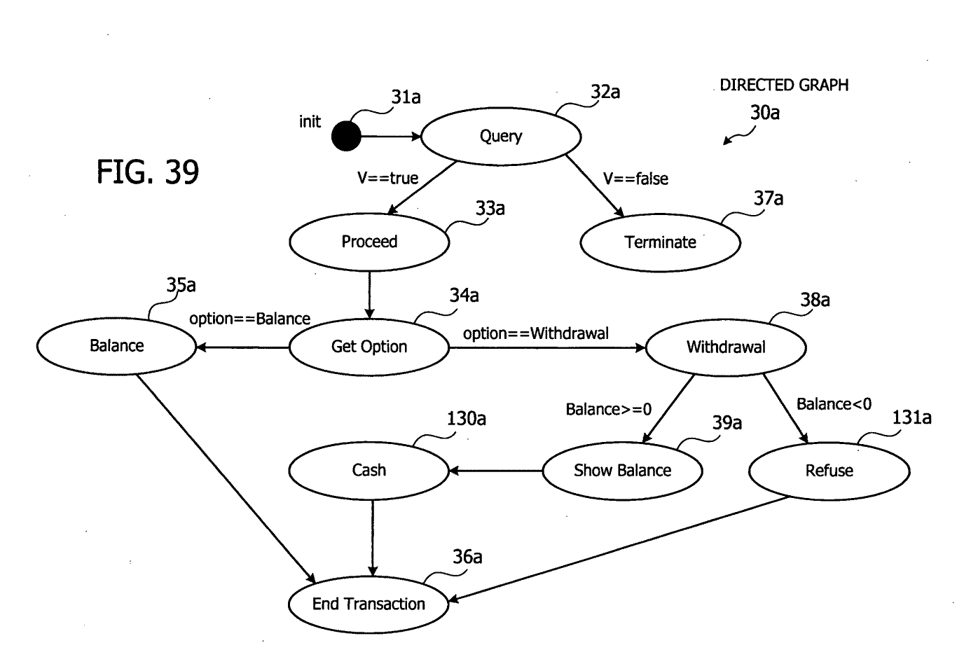

The message sequence charts of those scenarios can be compiled into a single directed graph. FIG. 39 illustrates relationships between message sequence charts and their hierarchical structure according to the third embodiment. The illustrated directed graph 30a is formed from an initial state block 31a, and message sequence charts 32a to 39a, 130a, and 131a to represent ten interactions. That is, combinations of these ten interactions realize various scenarios described in scenario blocks 52a, 52b, 53a, 53b, and 53c of FIG. 38. The message sequence chart 32a in FIG. 39, for example, corresponds to message sequence chart “Query” of an MSC block 521a under the scenario block 52a. This means that the process of scenario “Query” of the scenario block 52a includes a message sequence defined by the message sequence chart 32a.

Each scenario gives a specific process flow as follows:

Scenario “Query” is directed to a path that begins at an initial state block 31a and goes through message sequence charts 32a, 33a, 34a, 35a, and 36a. Specifically, if guard condition “V==true” is met as a result of the first message sequence chart 32a, the process moves to the next message sequence chart 33a. Upon completion of this message sequence chart 33a, the process moves to the next message sequence chart 34a. If guard condition “option==Balance” is met as a result of the message sequence chart 34a, then the process moves to the next message sequence chart 35a. Upon completion of the message sequence chart 35a, the process moves to the next message sequence chart 36a. Completion of this message sequence chart 36a means the end of scenario “Query.”

Scenario “Query Authentication Failed” is directed to a path that begins at the initial state block 31a and goes through message sequence charts 32a and 37a. Specifically, if guard condition “V==false” is met as a result of the first message sequence chart 32a, the process moves to the next message sequence chart 37a. Completion of this message sequence chart 37a means the end of scenario “Query Authentication Failed.”

Scenario “Withdraw Authentication Failed” is similar to the above scenario “Query Authentication Failed.” Specifically, after the first message sequence chart 32a is finished, the process moves to the next message sequence chart 37a when guard condition “V==false” is met. Completion of this message sequence chart 37a means the end of scenario “Query Authentication Failed.”

Scenario “Withdraw Done” is directed to a path that begins at the initial state block 31a and goes through message sequence charts 32a, 33a, 34a, 38a, 39a, 130a, and 36a. Specifically, if guard condition “V==true” is met as a result of the first message sequence chart 32a, the process moves to the next message sequence chart 33a. Upon completion of this message sequence chart 33a, the process moves to the next message sequence chart 34a. If guard condition “option==Withdrawal” is met as a result of the message sequence chart 34a, then the process moves to the next message sequence chart 38a. If guard condition “Balance>=0” is met as a result of the message sequence chart 38a, then the process moves to the next message sequence chart 39a. Upon completion of this message sequence chart 39a, the process moves to the next message sequence chart 130a. Upon completion of this message sequence chart 130a, the process moves to the final message sequence chart 36a. Completion of this message sequence chart 36a means the end of scenario “Withdraw Done.”

Scenario “Low Balance” is directed to a path that begins at the initial state block 31a and goes through message sequence charts 32a, 33a, 34a, 38a, 131a, and 36a. Specifically, if guard condition “V==true” is met as a result of the first message sequence chart 32a, the process moves to the next message sequence chart 33a. Upon completion of this message sequence chart 33a, the process moves to the next message sequence chart 34a. If guard condition “option==Withdrawal” is met as a result of the message sequence chart 34a, then the process moves to the next message sequence chart 38a. If guard condition “Balance<0” is met as a result of the message sequence chart 38a, then the process moves to the next message sequence chart 131a. Upon completion of this message sequence chart 131a, the process moves to the final message sequence chart 36a. Completion of this message sequence chart 36a means the end of scenario “Low Balance.”

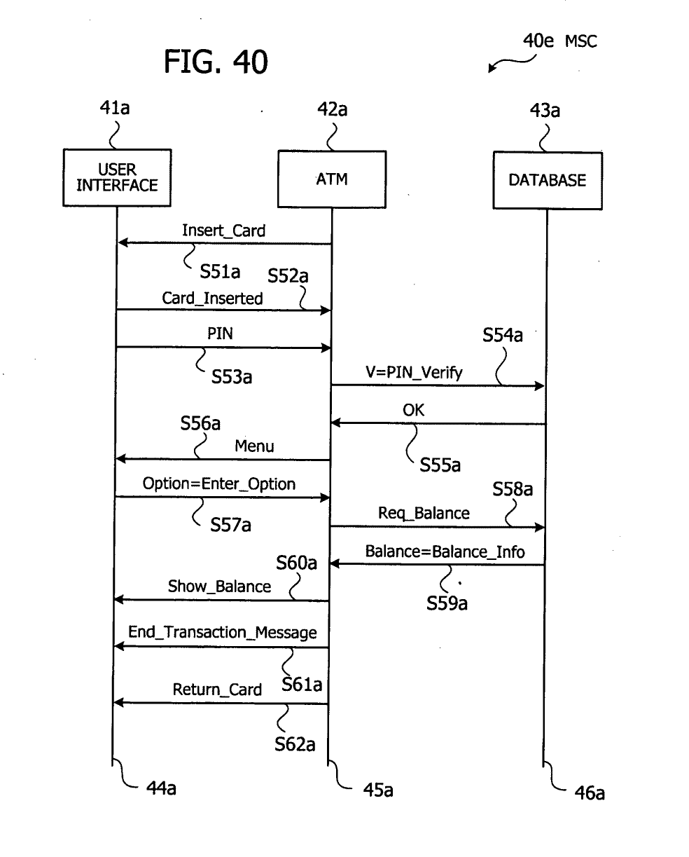

Take the scenario “Query” outlined above, for example. Referring to the message sequence chart of FIG. 40, more details of this scenario will now be discussed below.

The illustrated message sequence chart 40e represents scenario “Query” by depicting all interactions in the relevant message sequence charts 32a to 36a. Objects involved are a user interface 41a, ATM 42a, and a database 43a. These objects have their respective object lines, i.e., user interface line 44a, ATM line 45a, and database line 46a. Based on the rules noted earlier, the message sequence chart 40e gives the following process:

At the outset, The ATM 42a transmits a card insertion request message (Insert_Card) to the user interface 41a (step S51a). Upon receipt of this message, the user interface 41a sends a card insertion indication message (Card_Inserted) back to the ATM 42a (step S52a). The user interface 41a subsequently transmits an entered password (PIN) to the ATM 42a (step S53a). Upon receipt of the password, the ATM 42a transmits an authentication request (PIN_verify) message to the database 43a (step S54a). The operation up to this point is what is provided by the message sequence chart 32a.

The database 43a sends an OK message (OK) back to the ATM 42a (step S55a). This is what is provided by the message sequence chart 33a.

Upon receipt of the OK message, the ATM 42a send a display menu message (Menu) to the user interface 41a (step S56a). Subsequently, the user interface 41a receives entry of an option, thus sending an option entry message (Option=Enter_option) to the user interface 41a (step S57a). This is what is provided by the message sequence chart 34a.

Upon receipt of the option entry message, the ATM 42a transmits a balance query request message (Req_Balance) to the database 43a (step S58a). The database 43a returns the requested balance information (Balance=Balance_info) to the ATM 42a (step S59a). The ATM 42a sends a balance display message (Show_Balance) to the user interface 41a (step S60a). This is what is provided by the message sequence chart 35a.

The ATM 42a sends the user interface 41a a transaction complete message (End_Transaction_Message) (step S61a) and then a card return message (Return_card) (step S62a). This is what is provided by the message sequence chart 36a.

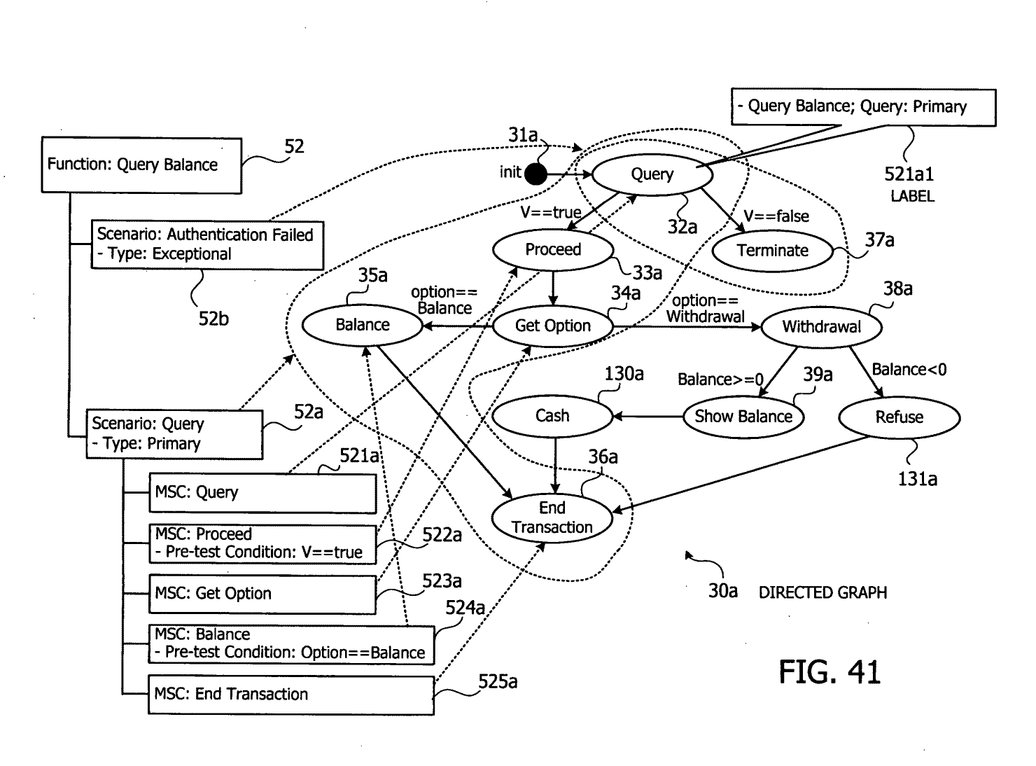

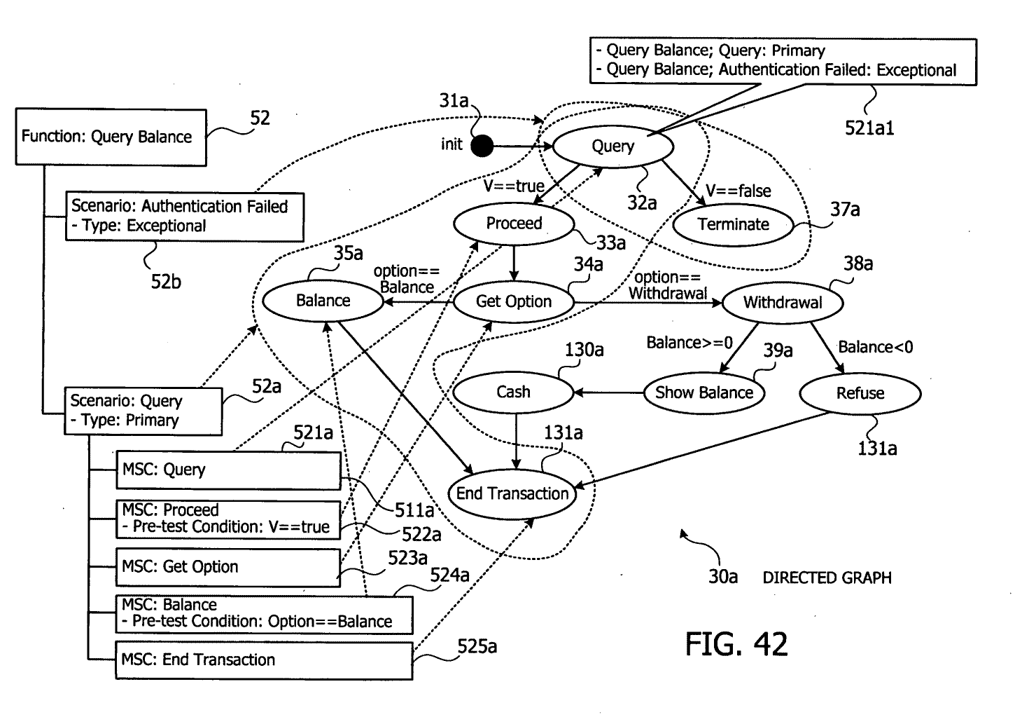

Referring now to FIGS. 41 and 42, the following description will present a specific example of how labels are added to an LSI design specification according to the third embodiment.

The labeling process first consults the LSI design specification 20 and selects function “Query Balance” of the function block 52. Out of the selected function, the process selects scenario “Query” of a scenario block 52a. Out of the selected scenario, the process then selects a message sequence chart 32a and adds a label to that chart. As described earlier, labels are supposed to include the names of currently selected function and scenario in the form of “function name; scenario name: scenario type.” Accordingly, in the example of FIG. 41, the message sequence chart “Query” is added a label 521a1 that reads: “Query Balance; Query: Primary.” FIG. 41 depicts processing results up to this point.

The labeling process then labels other message sequence charts in the same way as in the second embodiment. Specifically, the process selects another message sequence chart 33a involved in the currently selected scenario “Query” and adds a label “Query Balance; Query: Primary” to the selected message sequence chart 33a.

The process now selects yet another message sequence chart 34a involved in the currently selected scenario “Query” and adds a label “Query Balance; Query: Primary” to the selected message sequence chart 34a. The process also selects still another message sequence chart 35a involved in the currently selected scenario “Query” and adds a label “Query Balance; Query: Primary” to the selected message sequence chart 35a. The process further selects still another message sequence chart 36a involved in the currently selected scenario “Query” and adds a label “Query Balance; Query: Primary” to the selected message sequence chart 36a.

Now that the selected scenario “Query” is finished, the process turns to another scenario “Authentication Failed” of a scenario block 52b which is linked from the selected function block 52. The process thus selects message sequence charts in the selected scenario “Authentication Failed” one by one, so as to add a label to each selected message sequence chart.

FIG. 42 depicts processing results up to this point. That is, the label 521a1 has been revised with an additional line “Query Balance; Authentication Failed: Exceptional.” While other message sequence charts 33a, 34a, 35a, and 36a have also gained their labels as described above, FIG. 42 omits them for simplicity purposes.

Completion of labeling of message sequence charts in the selected scenario “Authentication Failed” marks the end of the labeling process for the function block 52 as a whole, including both scenario blocks 52a and 52b. Accordingly, the process turns to the LSI design specification 20 again and now selects another function “Withdraw” defined in a function block 53. Based on the selected function block 53, the process selects scenario “Authentication Failed” of a scenario block 53a. The process thus selects message sequence charts in the selected scenario “Authentication Failed” one by one, so as to add a label to each selected message sequence chart.

Now that the labeling for the selected scenario “Authentication Failed” is completed, the process turns to another scenario “Withdraw Done” of a scenario block 53b which is linked from the selected function block 53. The process thus selects message sequence charts in the selected scenario “Withdraw Done” one by one, so as to add a label to each selected message sequence chart.

Now that the labeling for the selected scenario “Withdraw Done” is completed, the process turns to another scenario “Low Balance” of a scenario block 53c which is linked from the selected function block 53. The process thus selects message sequence charts in the selected scenario “Low Balance” one by one, so as to add a label to each selected message sequence chart.

Completion of the labeling of all message sequence charts in the selected scenario “Low Balance” marks the end of the labeling process for the function block 53 as a whole, including all constituent scenario blocks 53a, 53b, and 53c. The process thus searches the LSI design specification 20, only to find no functions left there. The labeling process thus terminates itself.

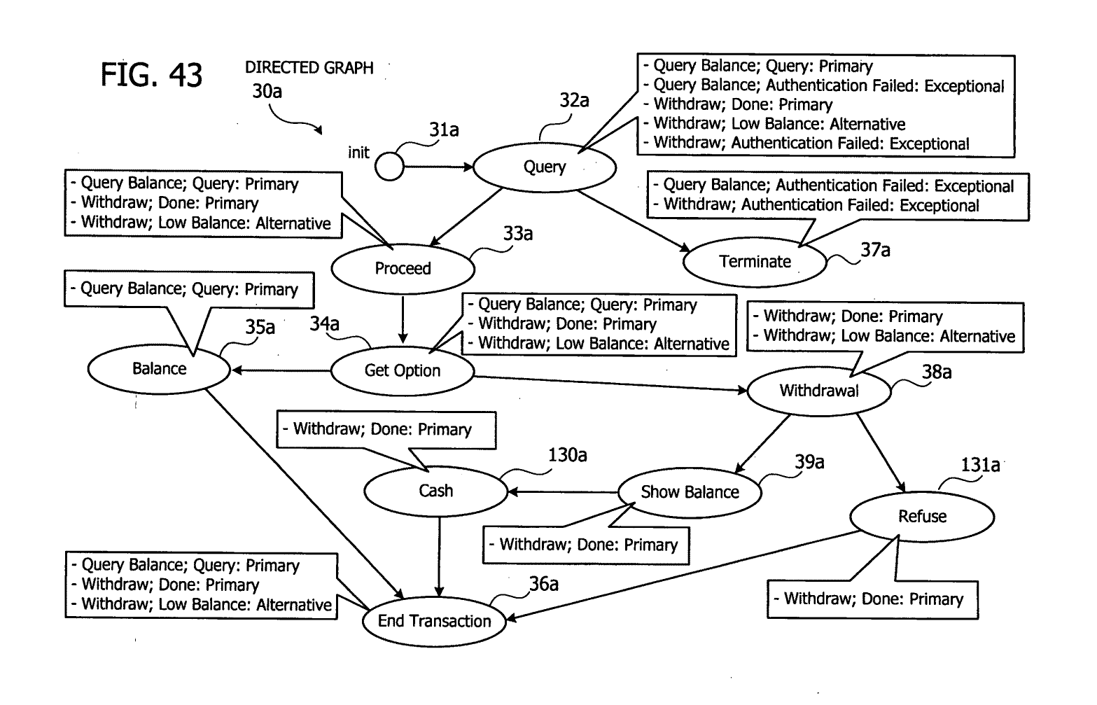

FIG. 43 illustrates a directed graph which has undergone the above-described labeling process. See, for example, the label of a message sequence chart 32a. This label contains all labels of scenarios “Query,” “Query Authentication Failed,” “Withdraw Authentication Failed,” “Withdraw Done,” and “Low Balance” because the message sequence chart 32a is included in all of those scenarios. By contrast, another message sequence chart 35a appears only in scenario “Query” and is thus given a single label that is derived from scenario “Query.”

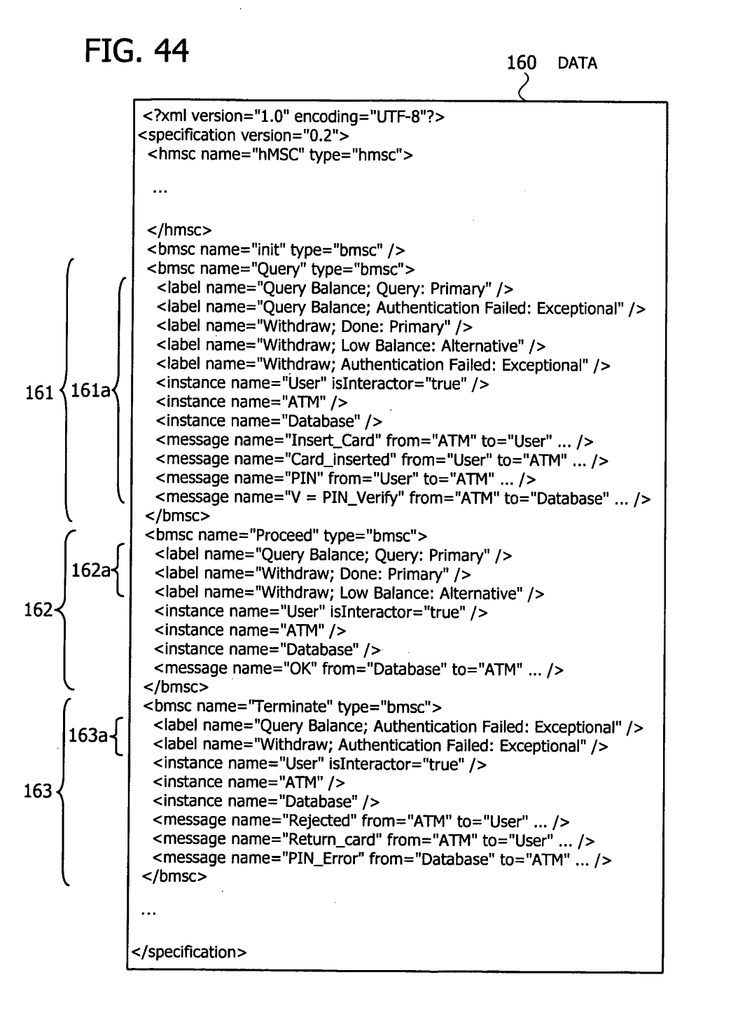

FIG. 44 illustrates an example data structure of a labeled LSI design specification. The illustrated data 160 describes a labeled version of the LSI design specification 20 in the XML format. The data 160 includes, among others, a plurality of descriptions 161 to 163. The first description 161 describes a message sequence chart 32a. The second description 162 describes another message sequence chart 33a. The third description 163 describes yet another message sequence chart 37a.

Those descriptions 161, 162, and 163 include new lines 161a, 162a, and 163a, respectively, which have been added by the foregoing labeling process, as indicated by the XML tag <label name>. The contents of each tag derive from the corresponding labels added to the finite state machine.

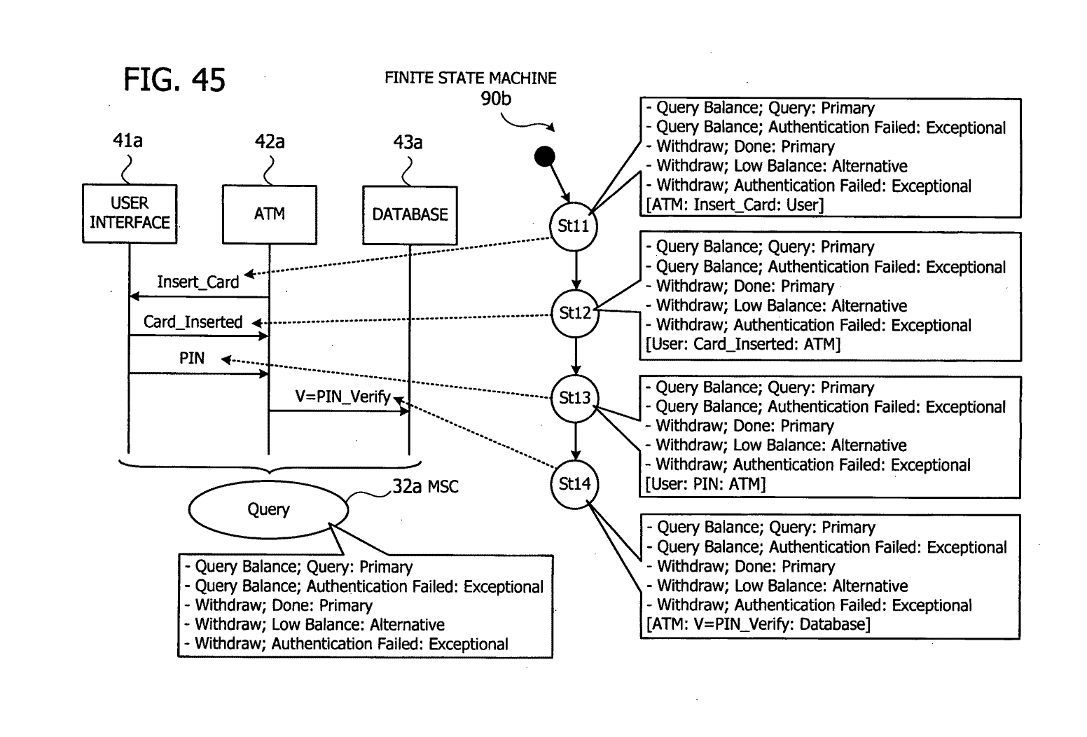

Referring now to FIG. 45 and subsequent drawings, the following description will present a specific example of how the process of step S15a (FIG. 36) operates.

FIG. 45 illustrates an example of object names added to labels. Using the same method as the second embodiment, the process produces a finite state machine 90b with states corresponding to data event messages in a given message sequence chart. Each machine state is then labeled with the labels of that message sequence chart. In the present example, four machine states St11, St12, St13, and St14 have been produced from a message sequence chart 32a as can be seen in FIG. 45.

The message sequence chart 32a has five labels that read: “Query Balance; Query: Primary,” “Query Balance; Authentication Failed: Exceptional,” “Withdraw; Done: Primary,” “Withdraw; Low Balance: Alternative,” and “Withdraw; Authentication Failed: Exceptional.”Accordingly, the same set of labels has been assigned to the four state St11, St12, St13, and St14.

The labels of those states St11, St12, St13, and St14 also contains some additional information, i.e., the name of a message and its associated object names indicating the sender and receiver of the message. In the example of FIG. 45, the labels of state St11 contain message name “Insert_Card,” transmitting object name “ATM” (indicating ATM 42a), and receiving object name “User” (indicating user interface 41a). Similarly, the label of state St12 contains message name “Card_Inserted,” transmitting object name “User” (indicating user interface 41a), and receiving object name “ATM” (indicating ATM 42a). The label of state St13 contains message name “PIN,” transmitting object name “User” (indicating user interface 41a), and receiving object name “ATM” (indicating ATM 42a). The label of state St14 contains message name “V=PIN_Verify,” transmitting object name “ATM” (indicating ATM 42a), and receiving object name “Database” (indicating database 43a).

The other message sequence charts 33a to 39a, 130a, and 131a are also processed in the same way as above. Some labels may already have such additional contents. If this is the case, the corresponding labeling task may be skipped. Or alternatively, those existing labels may simply be overwritten.

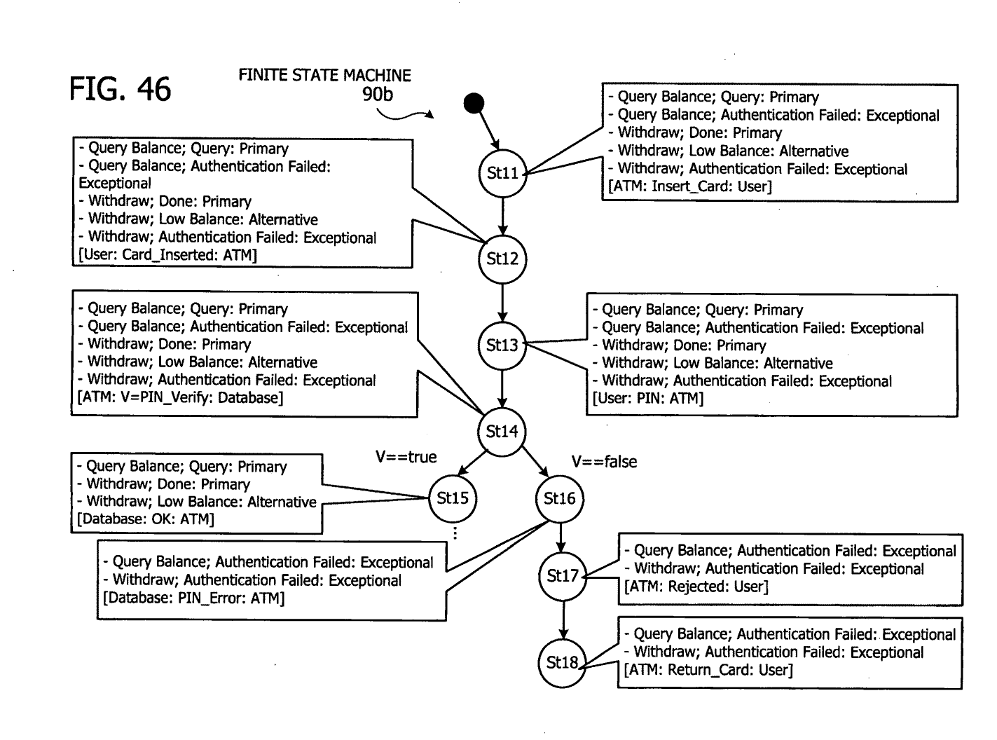

FIG. 46 depicts a final view of the labeled finite state machine. As can be seen in FIG. 46, the finite state machine has gained states St15 and so on from a message sequence chart 33a. This message sequence chart 33a is labeled with “Query Balance; Query: Primary,” “Withdraw; Done: Primary,” “Withdraw; Low Balance: Alternative” (see FIG. 43). Accordingly, the same set of labels has been assigned to state St15. The labels of state St15 also contain message name “OK,” transmitting object name “Database” (indicating database 43a), and receiving object name “ATM” (indicating ATM 42a).

The finite state machine has further gained states St16, St17, and St18 from the message sequence chart 37a. This message sequence chart 37a is labeled with “Query Balance; Authentication Failed: Exceptional” and “Withdraw; Authentication Failed: Exceptional” (see FIG. 43). Accordingly, the same set of labels has been assigned to states St16, St17, and St18.

The labels of state St16 also contain message name “PIN,” transmitting object name “Database” (indicating database 43a), and receiving object name “ATM” (indicating ATM 42a). Likewise, the label of state St17 contains message name “Rejected,” transmitting object name “ATM” (indicating ATM 42a), and receiving object name “User” (indicating user interface 41a). The label of state St18 contains message name “Return_Card,” transmitting object name “ATM” (indicating ATM 42a), and receiving object name “User” (indicating user interface 41a).

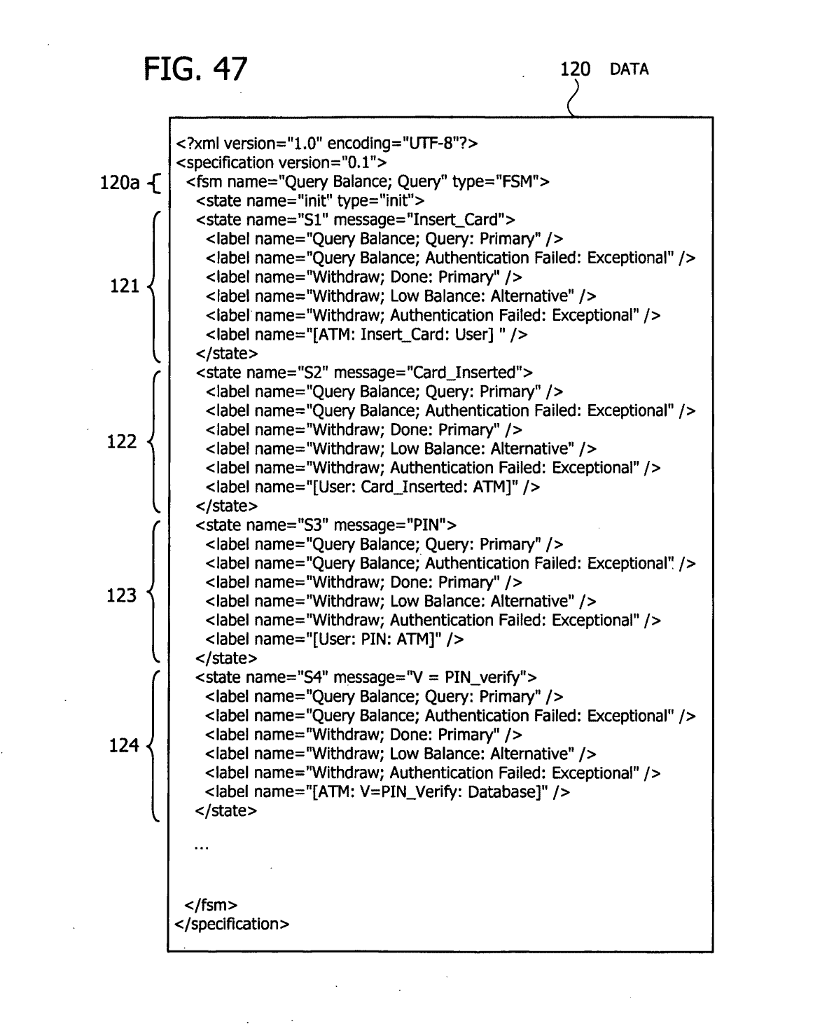

FIG. 47 illustrates a data structure of the finite state machine 90b with labels to which message names and object names of sending and receiving ends have been added. The illustrated data 120 describes the finite state machine 90b in the XML format, including (among others) descriptions 120a and 121 to 124. Description 120a gives an identifier of the finite state machine 90b in a finite state machine tag <fsm name> indicating that what is described in the data 120 is a finite state machine. The contents of each tag derive from the corresponding labels added to the finite state machine.

Other descriptions 121 to 124 correspond to states St11 to St14, respectively. Although not illustrated in FIG. 47, the data 120 also describes other states St15 to St18 of the finite state machine 90b.

The next several sections provide specific examples of verification scenario extraction, based on the message sequence chart 40e of FIG. 40, directed graph 30a of FIG. 43, and finite state machine 90b of FIG. 46.

### (a) Verification Scenario Extraction

### Example #1

This example #1 illustrates the case where the following coverage base is specified:

message=“PIN_Error”

The verification scenario extraction process first selects this message=“PIN_Error” as an element of the coverage base (which is actually the only element). The selected element may be found in the labels affixed to some states of the finite state machine 90b. The process extracts verification scenarios corresponding to such states.

Referring to FIG. 46, state St16 has “PIN_Error” in its label. The process thus extracts out of the verification scenario database 12 a collection of verification scenarios having the same labels of “Query Balance; Authentication Failed: Exceptional” and “Withdraw; Authentication Failed: Exceptional” as the state St16 has.

As the above-noted element is the only element of the given coverage base, the extraction process finds no element. Accordingly, the verification scenarios extracted above are supplied to the output processor 14 as a qualified set of verification scenarios. The output processor 14 outputs the scenario name of each extracted verification scenario, i.e., “Query Balance; Authentication Failed Exceptional” and “Withdraw; Authentication Failed Exceptional.”

### (b) Verification Scenario Extraction

### Example #2

This example #2 illustrates the case where the following coverage base is specified:

(message=“Menu”)&&(scenariotype=“altscenario”)

where symbol “&&” represents intersection. The second term (scenariotype=“altscenario”) means that an alternative operation is selected.

The verification scenario extraction process first selects message=“Menu” as an element of the coverage base. The selected element may be found in the labels affixed to some states of the finite state machine 90b. The process extracts verification scenarios corresponding to such states from the verification scenario database 12.

Referring to the message sequence chart 40e of FIG. 40 and the directed graph 30a of FIG. 43, the element message=“Menu” is found only in the message sequence chart 34a. The process thus extracts out of the verification scenario database 12 a collection of verification scenarios having the same labels of “Query Balance; Query: Primary,” “Withdraw; Done: Primary,” and “Withdraw; Low Balance: Alternative” as the message sequence chart 34a has.

It is then determined whether there is any other element of the coverage base. The process then selects another element scenariotype=“altscenario” of the coverage base since it has not been selected. The selected element may be found in the labels affixed to some states of the finite state machine 90b. The extraction process seeks verification scenarios corresponding to such states from the verification scenario database 12. In the present example, scenario “Withdraw; Low Balance: Alternative” is the only scenario that contains alternative operation. The process thus extracts out of the verification scenario database 12 a collection of verification scenarios that have “Withdraw; Low Balance: Alternative” in their labels.

It is then determined whether there is any other element in the coverage base. Since no unselected element is present, the process calculates an intersection of the extracted sets of verification scenarios.

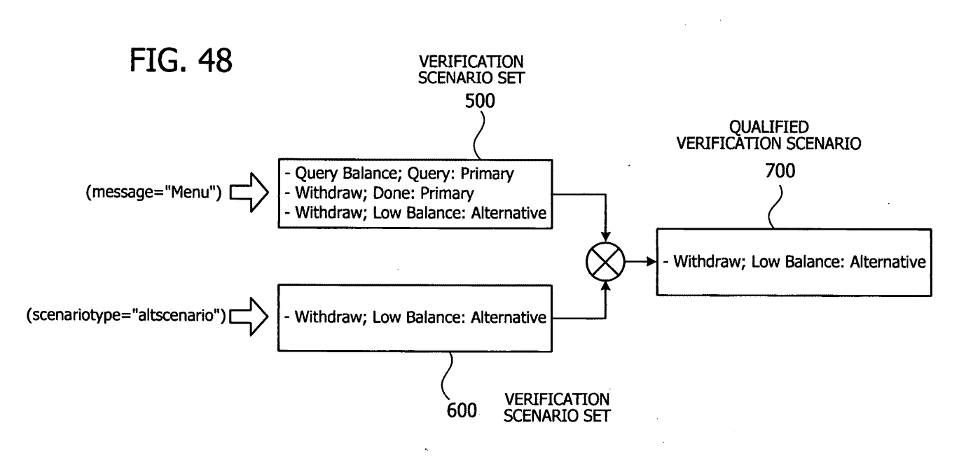

FIG. 48 illustrates how an intersection of extracted verification scenarios is calculated. FIG. 48 gives two sets of verification scenarios. One verification scenario set 500 has been extracted with a coverage base element (message=“Menu”) while another verification scenario set 600 has been extracted with another element (scenariotype=“altscenario”). Note that the verification scenarios in FIG. 48 are distinguished by their labels in the form of “function name; scenario name: scenario type.”

The above two verification scenario sets 500 and 600 share a single verification scenario “Withdraw; Low Balance Alternative.” The extraction process therefore sends that shared scenario to the output processor 14 as a qualified verification scenario 700 fulfilling the given coverage base. Finally, the output processor 14 outputs the name of this verification scenario 700.

### (c) Verification Scenario Extraction

### Example #3

This example #3 illustrates the case where the following coverage base is specified:

(message=“Menu”)&&(object=“ATM”)

The verification scenario extraction process first selects message=“Menu” as an element of the coverage base. The selected element may be found in the labels affixed to some states of the finite state machine 90b. The process extracts verification scenarios corresponding to such states from the verification scenario database 12.

Referring to the message sequence chart 40e of FIG. 40 and the directed graph 30a of FIG. 43, the element message=“Menu” is found only in the message sequence chart 34a. The process thus extracts out of the verification scenario database 12 a collection of verification scenarios having the same labels of “Query Balance; Query: Primary,” “Withdraw; Done: Primary,” and “Withdraw; Low Balance: Alternative” as the message sequence chart 34a has.

It is then determined whether there is any other element of the coverage base. The process then selects another element object=“ATM” of the coverage base since it has not been selected. The selected element may be found in the labels affixed to some states of the finite state machine 90b. The process extracts verification scenarios corresponding to such states from the verification scenario database 12. The result is the following five scenarios: “Query Balance; Query: Primary,” “Query Balance; Authentication Failed: Exceptional,” “Withdraw; Done: Primary,” “Withdraw; Low Balance: Alternative,” “Withdraw; Authentication Failed: Exceptional.”

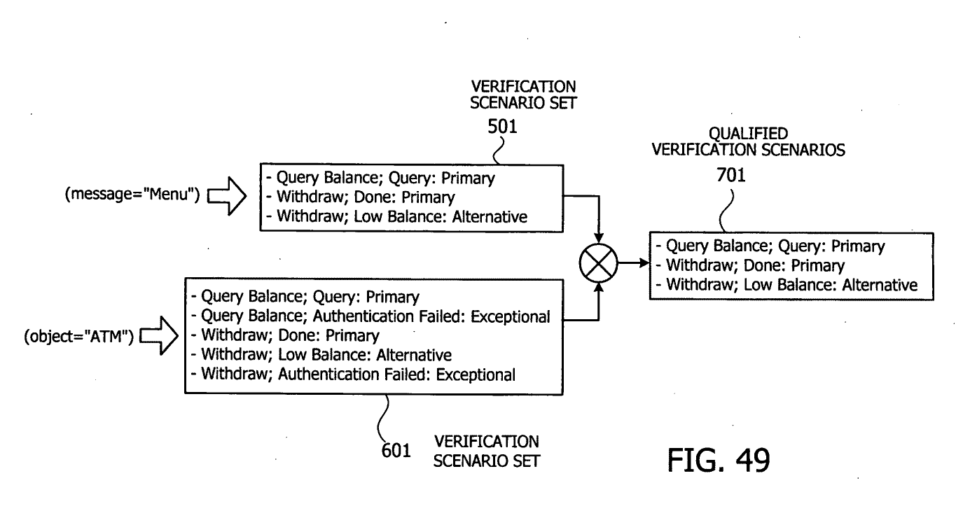

Since no unselected element is present in the coverage base, the process calculates an intersection of the extracted sets of verification scenarios. FIG. 49 illustrates how an intersection of extracted verification scenarios is calculated. Actually, FIG. 49 gives two sets of verification scenarios. One verification scenario set 501 has been extracted with a coverage base element (message=“Menu”), and the other verification scenario set 601 has been extracted with another element (object=“ATM”). Note that the verification scenarios in FIG. 49 are distinguished by their labels in the form of “function name; scenario name: scenario type.”

Those two verification scenario sets 501 and 601 share three scenarios: “Query Balance; Query: Primary,” “Withdraw; Done: Primary,” and “Withdraw; Low Balance: Alternative.” The extraction process therefore sends that shared scenario to the output processor 14 as qualified verification scenarios 701 fulfilling the given coverage base. Finally, the output processor 14 outputs the names of those verification scenarios 701.

In addition to providing advantageous features similarly to the foregoing second embodiment, the third embodiment described above offers the feature of dynamically changing coverage bases during the design and verification phase. Specifically, the proposed design verification apparatus extracts a new set of verification scenarios satisfying a revised coverage base, making it possible to continue the work in design phase by executing those extracted verification scenarios.

The coverage base may be determined from a viewpoint that is different from the existing ones. For example, the user may specify a coverage base at the level of specification to compensate for what is missing in the conventional implementation-oriented coverage base, thus improving the efficiency of verification. Coverage bases may include, but not limited to, the following choices:

(1) In the case where the specification of an object has been changed, or where the verification has to concentrate on a specific object, it is appropriate to perform exhaustive verification with all scenarios using that object. Preferably the coverage base in this case specifies the name of the object in question.

(2) After bug fixing in a data event message, it is appropriate to perform exhaustive verification with all scenarios using that data event message. In this case, the coverage base may preferably specify the name of the data event message in question.

(3) The initial stage of verification may focus on the primary operations, while leaving exceptional operations behind. In this case, the user may wish to concentrate on such exceptional operations in the last part of the design period. For exhaustive verification of scenarios including exceptional operation on a specific object, the coverage base may preferably specify an intersection in the following form: “object name && senariotype=Exceptional.”

### Computer-Readable Storage Media

The above-described design verification apparatus is provided as a hardware system including, but not limited to, a computer platform as discussed in FIG. 9. The processing functions of the proposed design verification apparatus may also be implemented as a program product for execution on a computer system, in which case the functions of the proposed design verification apparatus are encoded and provided in the form of computer programs. A computer system executes such programs to provide the above-described processing functions.

The above computer programs may be stored in a computer-readable medium for the purpose of storage and distribution. Suitable computer-readable storage media include, but not limited to, magnetic storage devices, optical discs, magneto-optical storage media, and semiconductor memory devices, for example. Magnetic storage devices include hard disk drives (HDD), flexible disks (FD), and magnetic tapes, for example. Optical discs include digital versatile discs (DVD), DVD-RAM, compact disc read-only memory (CD-ROM), CD-Recordable (CD-R), and CD-Rewritable (CD-RW), for example. Magneto-optical storage media include magneto-optical discs (MO), for example.

Portable storage media, such as DVD and CD-ROM, are suitable for distribution of program products. Network-based distribution of software programs may also be possible, in which case several master program files are made available on a server computer for downloading to other computers via a network.

To execute a design verification program, the computer stores necessary software components in its local storage unit, which have previously been installed from a portable storage media or downloaded from a server computer. The computer executes the programs read out of the local storage unit, thereby performing the programmed functions. Where appropriate, the user computer may execute program codes read out of the portable storage medium, without previous installation of those programs in its local storage device. Another alternative method is that the user computer dynamically downloads programs from a server computer when they are demanded and executes them upon delivery.

### CONCLUSION

The above sections have described several embodiments of a design verification apparatus and a program therefor, which provide useful data for the purpose of efficient design verification. The proposed design verification apparatuses 10 and 10a may optionally be implemented on a multiple processor system for distributed processing. For example, one processing device generates verification scenarios, and another processing device assigns priorities to those verification scenarios.

The above-described embodiments may also be combined on an individual feature basis. For example, the verification scenarios produced by the third embodiment may be subjected to a priority setting process according to the second embodiment.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has(have) been described in detail, it should be understood that various changes, substitutions, and alterations could be made hereto without departing from the spirit and scope of the invention.

What is claimed is:

1. A design verification apparatus comprising:
a dataset generator to generate verification datasets which associate each unit process of a plurality of procedures described in a design specification of a target product with an identifier designating which portion of the design specification is to be verified;
a process priority setting unit to assign a process priority to each verification dataset according to specified identifiers; and
an output processor to output data identifying the verification datasets, together with explicit indication of process priorities thereof.

2. The design verification apparatus according to claim 1, wherein the dataset generator extracts a set of unit processes sharing a specific identifier and provides the extracted set of unit processes as a verification dataset.

3. The design verification apparatus according to claim 1, wherein:
the unit processes each comprise a sequence of signals exchanged between objects; and
the dataset generator associates each sequence with the identifier associated with the corresponding unit process.

4. The design verification apparatus according to claim 3, wherein the dataset generator produces state machines from the sequences and assigns the identifiers of the corresponding source sequences to states of the produced state machines.

5. The design verification apparatus according to claim 4, wherein:
said identifier designating a portion of the design specification indicates a function, or a procedure, or a sequence, or a combination thereof, which is offered by said portion; and
the dataset generator extracts a part of the state machines whose states share a specific identifier, and outputs the extracted partial state machine as a verification dataset.

6. The design verification apparatus according to claim 4, wherein the dataset generator reduces the number of states of the sequences, based on a specified constraint on the sequences.

7. The design verification apparatus according to claim 1, wherein the process priority setting unit assigns a specific process priority equally to all verification datasets associated with one of the specified identifiers.

8. The design verification apparatus according to claim 1, wherein:
the specified identifiers have priorities assigned; and
the process priority setting unit assigns, to the verification datasets corresponding to one of the specified identifiers, a process priority determined from the priority assigned to said one of the specified identifiers.

9. The design verification apparatus according to claim 7, wherein the process priority assigned to the verification datasets by the process priority setting unit permits a portion of the design specification that corresponds to said one of the specified identifiers to be verified in preference to other portions of the same.

10. A computer-readable storage medium encoded with a design verification program which is executed by a computer to cause the computer to perform a method comprising:
generating verification datasets which associate each unit process of a plurality of procedures described in a design specification of a target product with an identifier designating which portion of the design specification is to be verified;
assigning a process priority to each verification dataset according to specified identifiers; and
outputting data identifying the verification datasets, together with explicit indication of process priorities thereof.

11. A design verification apparatus comprising:
a dataset generator to generate verification datasets which associate each unit process of a plurality of procedures described in a design specification of a target product with an identifier designating, on an object basis, which portion of the design specification is to be verified;
a dataset selector to select at least one of the generated verification datasets according to an input from an external source; and
an output processor to output data identifying the verification dataset selected by the dataset selector.

12. The design verification apparatus according to claim 11, wherein:
the identifier includes signal names to identify signals exchanged between objects and object names to identify the objects;
said input from an external source specifies a specific object name; and
the dataset selector selects verification datasets that correspond to the identifier including the object name specified by said input.

13. The design verification apparatus according to claim 12, wherein:
said input includes a logical expression to specify a condition; and
the dataset selector selects verification datasets that satisfy the condition specified by the logical expression.

14. The design verification apparatus according to claim 11, wherein the dataset generator extracts a set of unit processes that share a specific identifier and outputs the extracted set of unit processes as a verification dataset.

15. The design verification apparatus according to claim 11, wherein:
the unit processes each comprise a sequence of signals exchanged between objects; and
the dataset generator associates each sequence with the identifier associated with the corresponding unit process.

16. The design verification apparatus according to claim 15, wherein the dataset generator produces state machines from the sequences and assigns the identifiers of the corresponding source sequences to states of the produced state machines.

17. The design verification apparatus according to claim 16, wherein:
said identifier designating a portion of the design specification indicates a function, or a procedure, or a sequence, or a combination thereof, which is offered by said portion; and
the dataset generator extracts a part of the state machines whose states share a specific identifier, and outputs the extracted partial state machine as a verification dataset.

18. The design verification apparatus according to claim 16, wherein the dataset generator reduces the number of states of the sequences, based on a specified constraint on the sequences.

19. A computer-readable storage medium encoded with a design verification program which is executed by a computer to cause the computer to perform a method comprising:
generating verification datasets which associate each unit process of a plurality of procedures described in a design specification of a target product with an identifier designating, on an object basis, which portion of the design specification is to be verified;
selecting at least one of the generated verification datasets according to an input from an external source; and
outputting data identifying the selected verification dataset.
